(19) United States
(12) Patent Application Publication
(10) Pub. No.: US 2024/0045040 A1
(43) Pub. Date: Feb. 8, 2024

(54) DETECTING OBSTRUCTIONS

(71) Applicant: Innoviz Technologies Ltd., Rosh Haayin (IL)

(72) Inventors: Omri Tennenhaus, Jerusalem (IL); Idan Bakish, Hod Hasharon (IL); Oren Navon, Ganei Tikva (IL); Ido Amrani, Modi'in-Maccabim-Re'ut (IL); Ronen Eshel, Herzliya (IL); Yuval Yifat, Tel Aviv-Yafo (IL); Natali Revivo, Tirat Carmel (IL)

(73) Assignee: Innoviz Technologies Ltd., Rosh Haayin (IL)

(21) Appl. No.: 18/364,467

(22) Filed: Aug. 2, 2023

Related U.S. Application Data
(60) Provisional application No. 63/370,382, filed on Aug. 4, 2022.

(51) Int. Cl. G01S 7/497; G01S 7/4861; G01S 7/486

(52) U.S. Cl. CPC G01S 7/497; G01S 7/4861; G01S 7/4868; G01S 2007/4975

(57) ABSTRACT

A LIDAR system for detecting an obstruction on a window that is associated with the LIDAR system, the LIDAR system includes at least one processor configured to detect, based on detection signals generated by an obstruction sensor of the LIDAR system, an obstruction that at least partially obstructs a passage of light through the window. The obstruction sensor differs from an object related sensor of the LIDAR system that is configured to detect of one or more objects within a field of view (FOV) of the LIDAR system.

### CROSS REFERENCE

This application claims priority from U.S. provisional patent Ser. No. 63/370,382 filing date Aug. 4, 2022 which is incorporated by reference.

### BACKGROUND

### I. Technical Field

The present disclosure relates generally to surveying technology for scanning a surrounding environment, and, more specifically, to systems and methods that detect obstructions.

### II. Background Information

With the advent of driver assist systems and autonomous vehicles, automobiles need to be equipped with systems capable of reliably sensing and interpreting their surroundings, including identifying obstacles, hazards, objects, and other physical parameters that might impact navigation of the vehicle. To this end, a number of differing technologies have been suggested including radar, LIDAR, camera-based systems, operating alone or in a redundant manner.

One consideration with driver assistance systems and autonomous vehicles is an ability of the system to determine surroundings across different conditions including, rain, fog, darkness, bright light, and snow. A light detection and ranging system, (LIDAR a.k.a LADAR) is an example of technology that can work well in differing conditions, by measuring distances to objects by illuminating objects with light and measuring the reflected pulses with a sensor. A laser is one example of a light source that can be used in a LIDAR system. As with any sensing system, in order for a LIDAR-based sensing system to be fully adopted by the automotive industry, the system should provide reliable data enabling detection of far-away objects.

The systems and methods of the present disclosure are directed towards improving performance of LIDAR systems.

### BRIEF DESCRIPTION

The accompanying drawings, which are incorporated in and constitute a part of this disclosure, illustrate various disclosed embodiments. In the drawings:

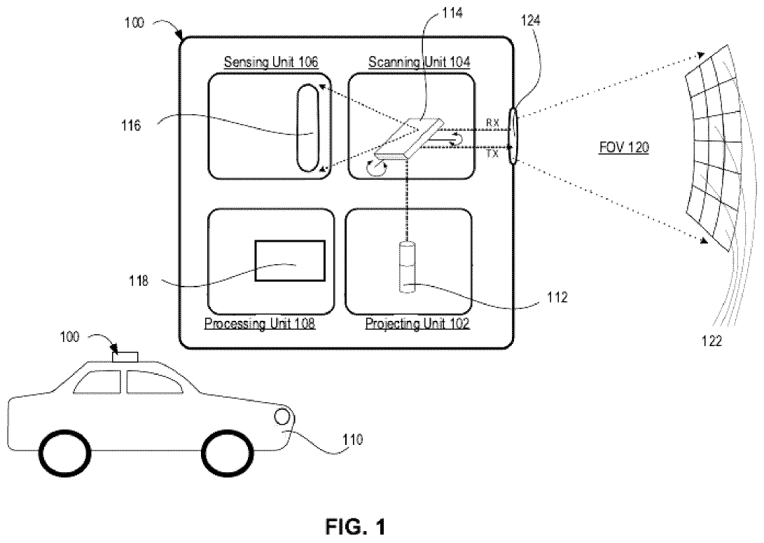

FIG. 1 illustrates an example of a LIDAR system;

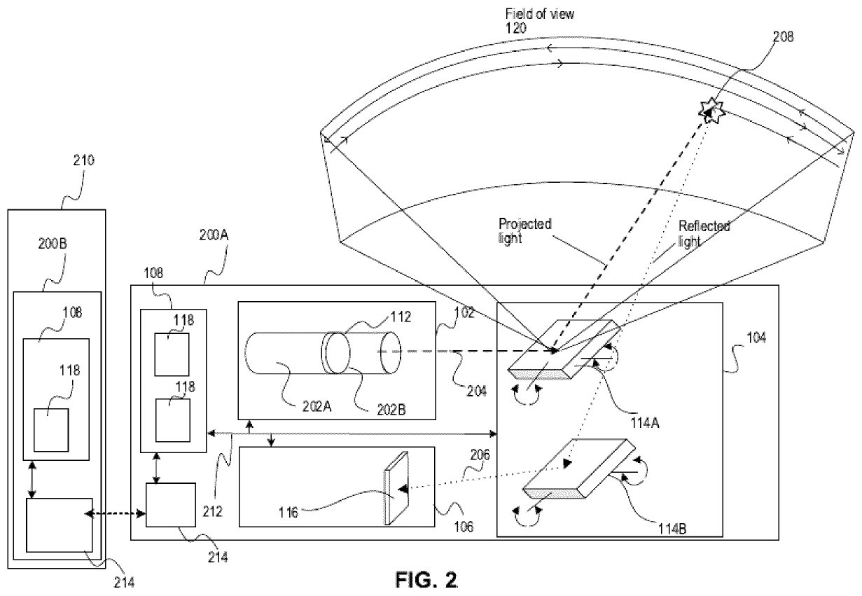

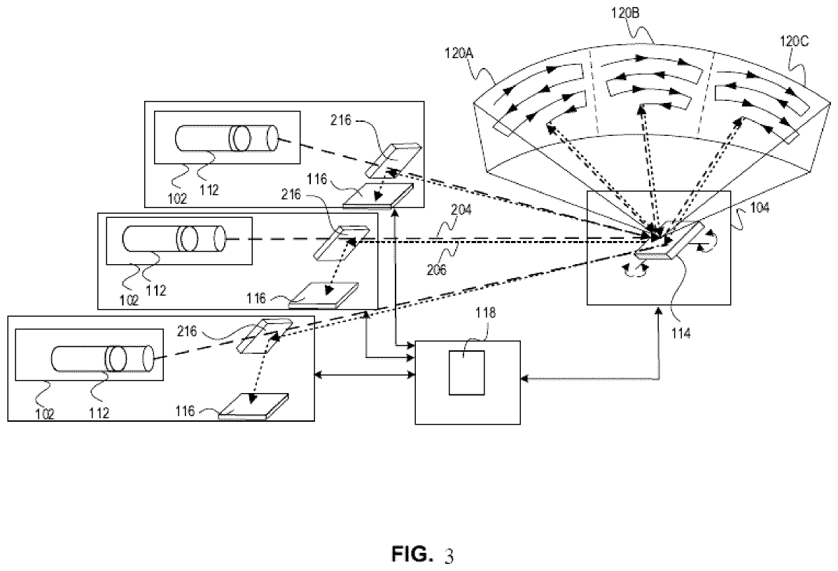

FIGS. 2 and 3 illustrate various configurations of a projecting unit and its role in a LIDAR system;

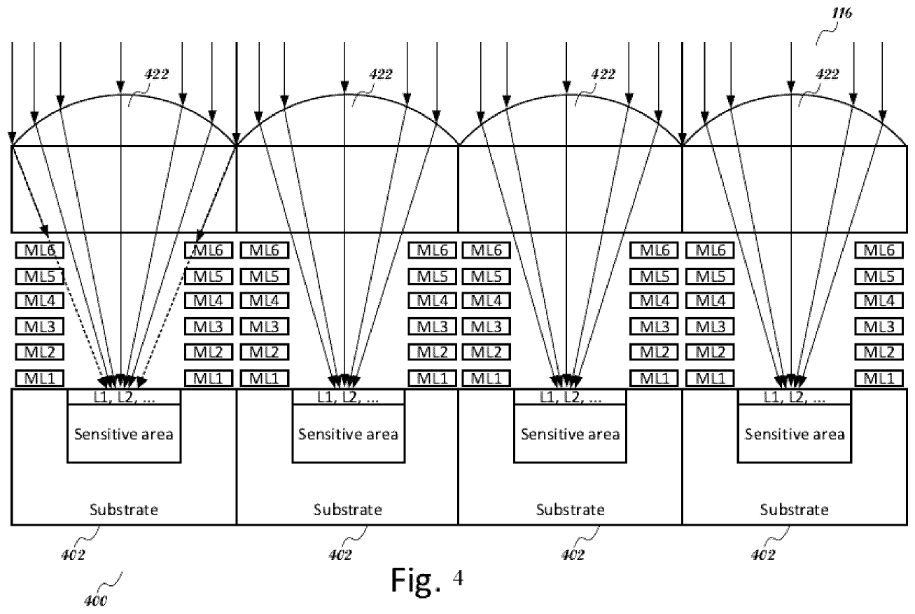

FIG. 4 is a cross cut diagram of a part of a sensor;

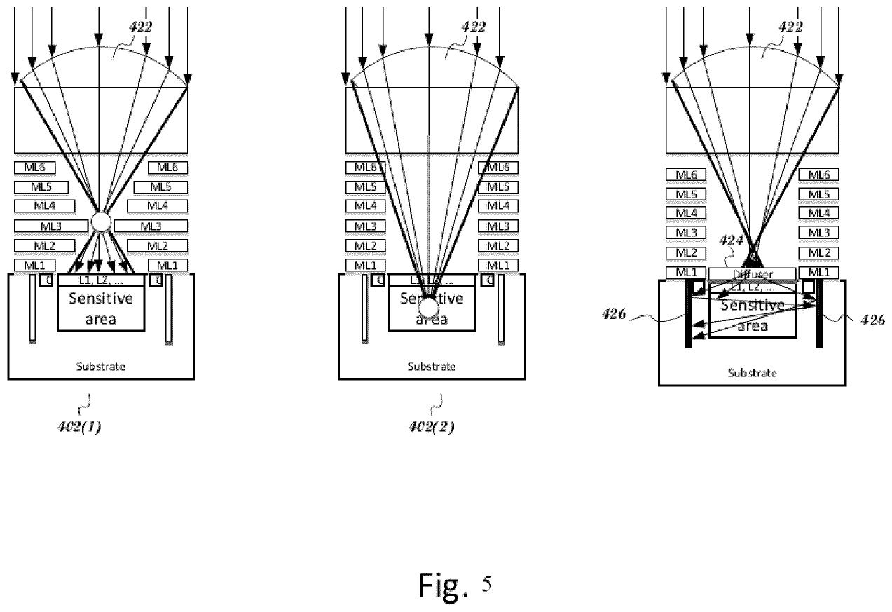

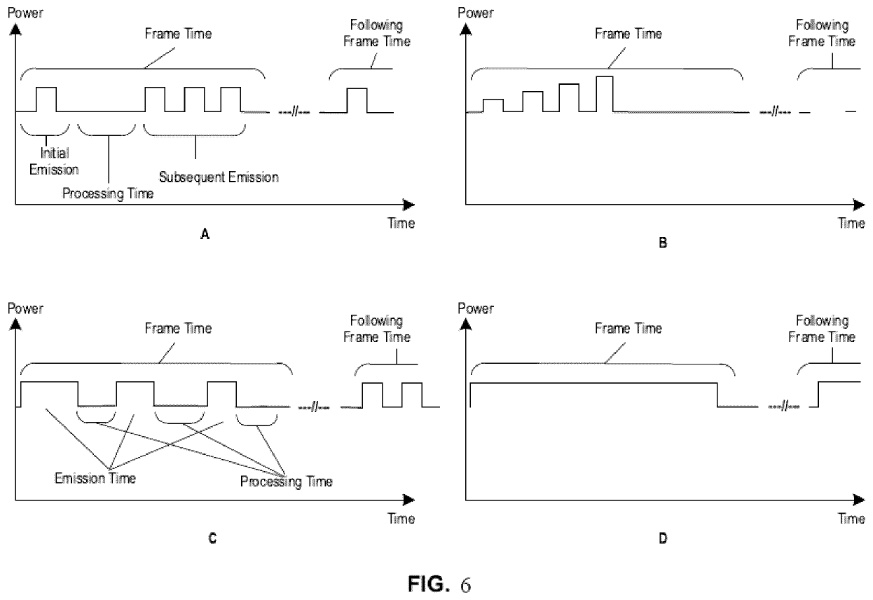

FIGS. 5 and 6 depict various configurations of a sensing unit and its role in a LIDAR system;

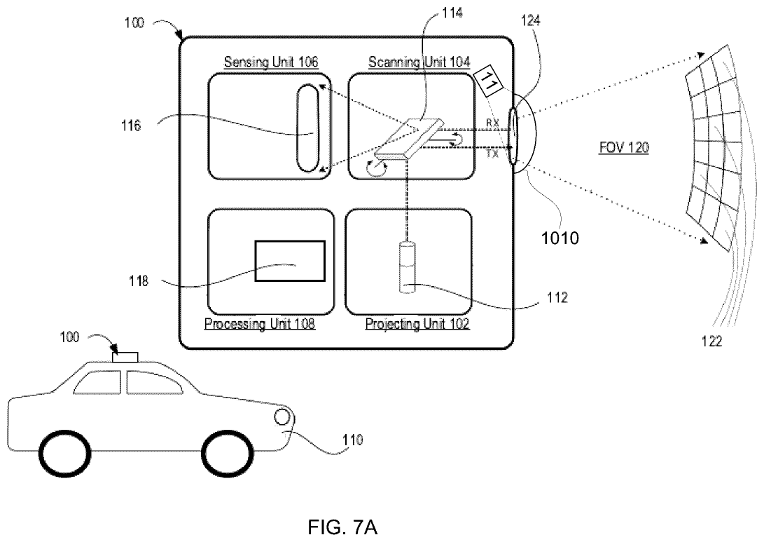

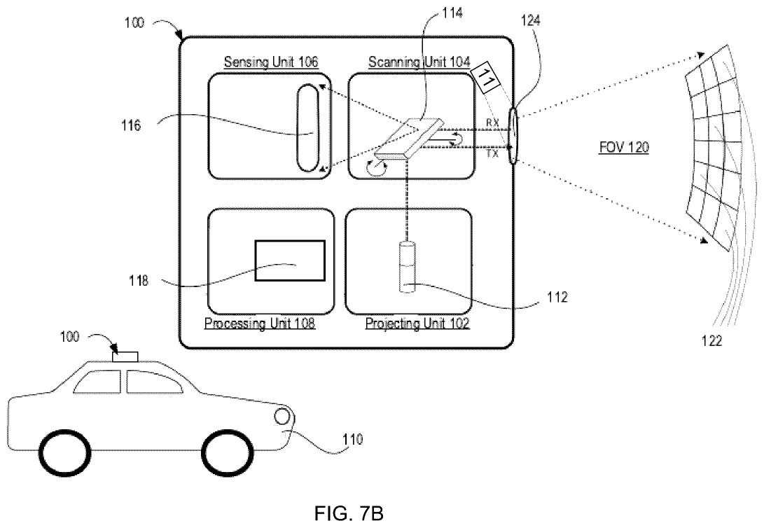

FIG. 7A illustrates an example of a LIDAR system;

FIG. 7B illustrates an example of a LIDAR system;

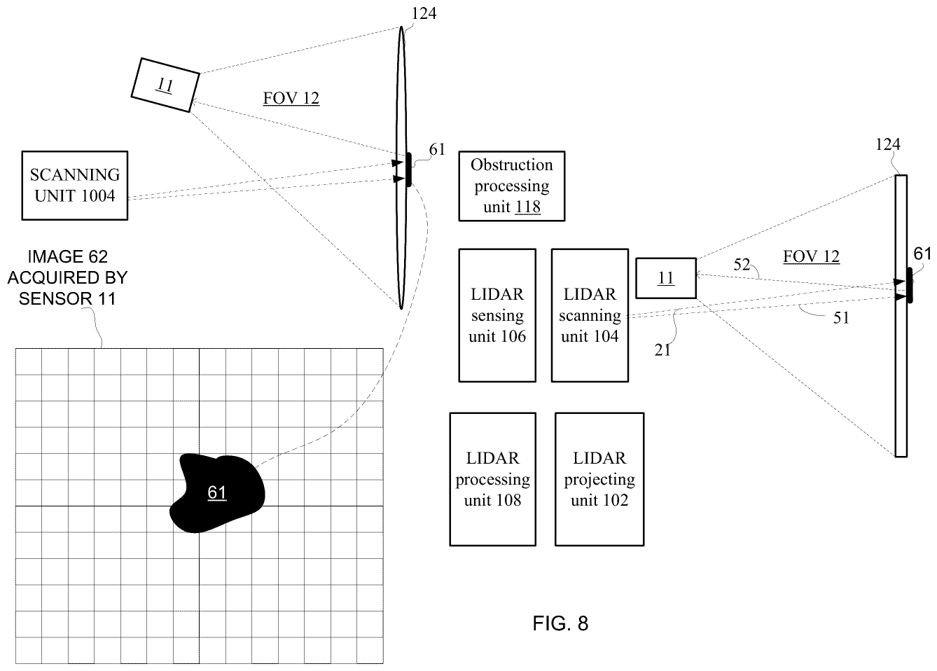

FIG. 8 illustrates an example of a LIDAR system;

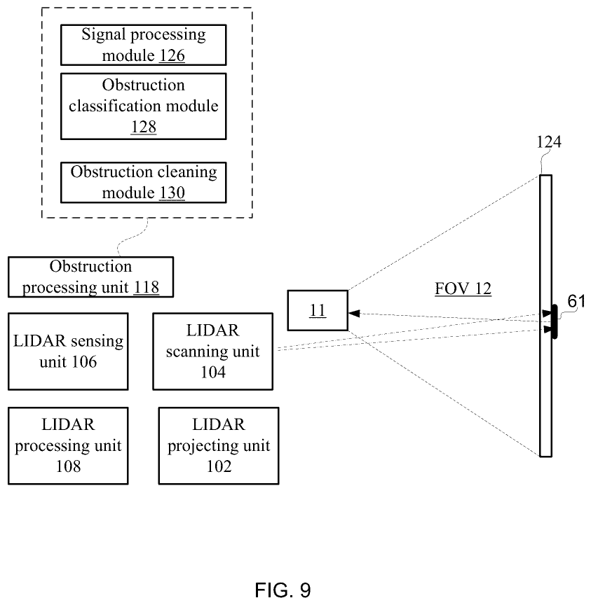

FIG. 9 illustrates an example of a LIDAR system;

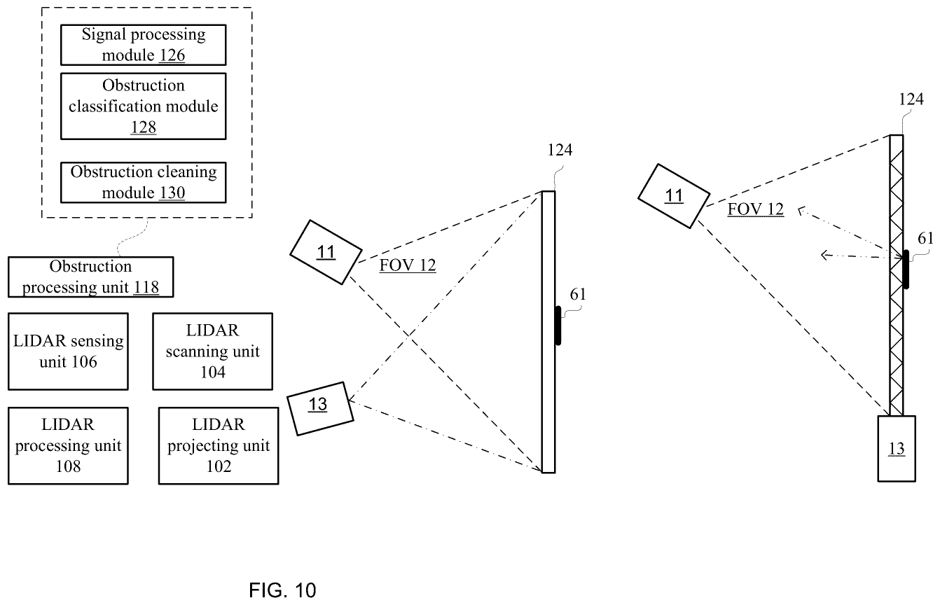

FIG. 10 illustrates an example of a LIDAR system;

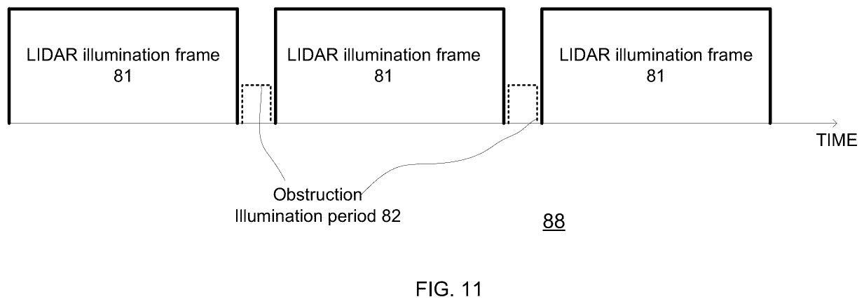

FIG. 11 illustrates an example of a timing diagram;

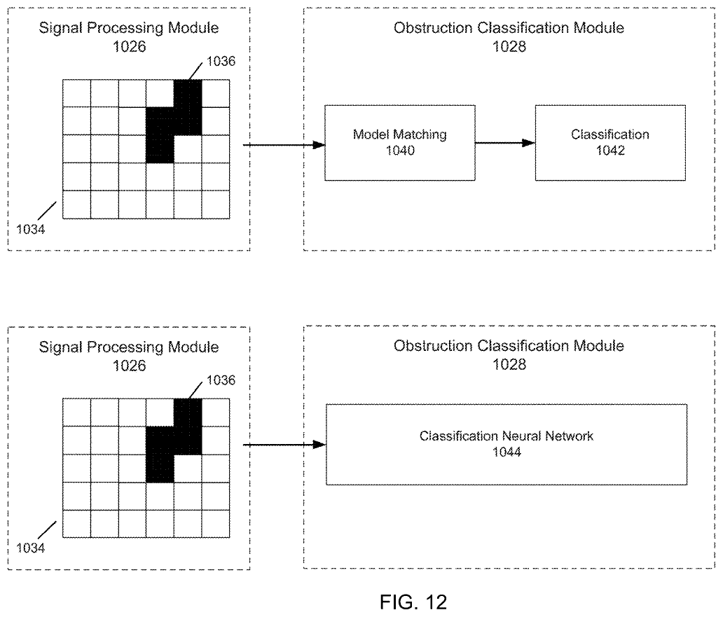

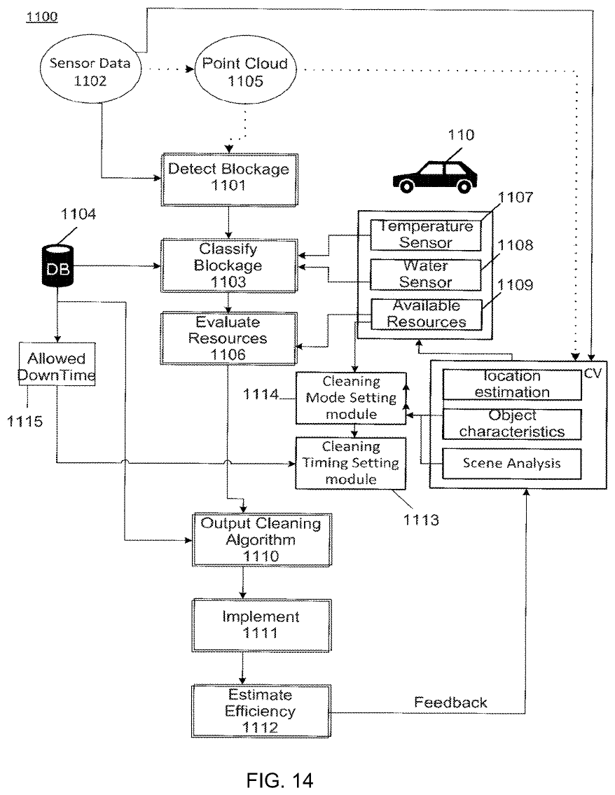

FIGS. 12-14 illustrate examples of classifications of obstructions;

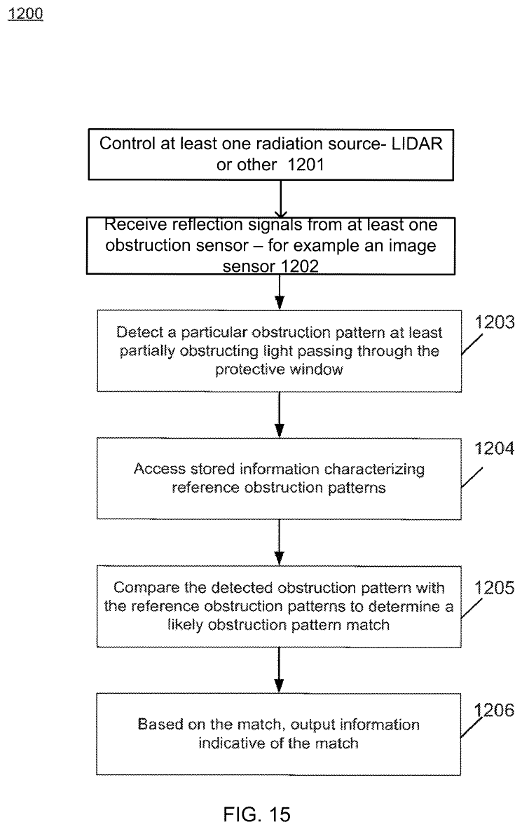

FIG. 15 illustrates a method;

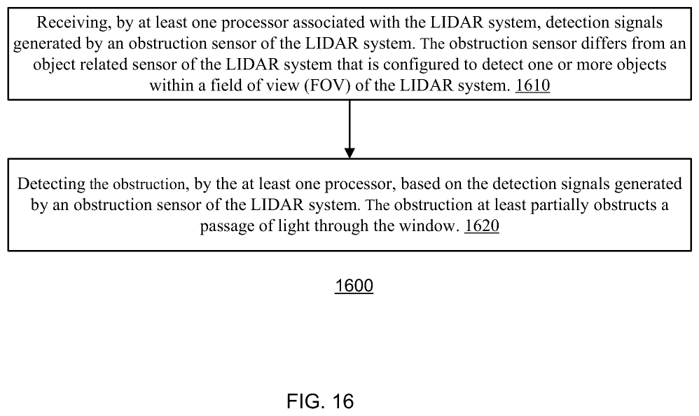

FIG. 16 illustrates a method; and

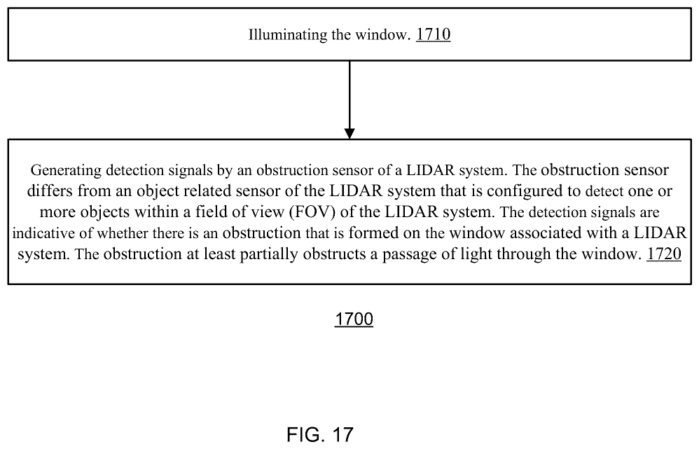

FIG. 17 illustrates a method.

### DETAILED DESCRIPTION

The accompanying drawings, which are incorporated in and constitute a part of this disclosure, illustrate various disclosed embodiments. The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

### Terms Definitions

Disclosed embodiments may involve an optical system. As used herein, the term “optical system” broadly includes any system that is used for the generation, detection and/or manipulation of light. By way of example only, an optical system may include one or more optical components for generating, detecting and/or manipulating light. For example, light sources, lenses, minors, prisms, beam splitters, collimators, polarizing optics, optical modulators, optical switches, optical amplifiers, optical detectors, optical sensors, fiber optics, semiconductor optic components, while each not necessarily required, may each be part of an optical system. In addition to the one or more optical components, an optical system may also include other non-optical components such as electrical components, mechanical components, chemical reaction components, and semiconductor components. The non-optical components may cooperate with optical components of the optical system. For example, the optical system may include at least one processor for analyzing detected light.

Consistent with the present disclosure, the optical system may be a LIDAR system. As used herein, the term “LIDAR system” broadly includes any system which can determine values of parameters indicative of a distance between a pair of tangible objects based on reflected light. In one embodiment, the LIDAR system may determine a distance between a pair of tangible objects based on reflections of light emitted by the LIDAR system. As used herein, the term “determine distances” broadly includes generating outputs which are indicative of distances between pairs of tangible objects. The determined distance may represent the physical dimension between a pair of tangible objects. By way of example only, the determined distance may include a line of flight distance between the LIDAR system and another tangible object in a field of view of the LIDAR system. In another embodiment, the LIDAR system may determine the relative velocity between a pair of tangible objects based on reflections of light emitted by the LIDAR system. Examples of outputs indicative of the distance between a pair of tangible objects include: a number of standard length units between the tangible objects (e.g. number of meters, number of inches, number of kilometers, number of millimeters), a number of arbitrary length units (e.g. number of LIDAR system lengths), a ratio between the distance to another length (e.g. a ratio to a length of an object detected in a field of view of the LIDAR system), an amount of time (e.g. given as standard unit, arbitrary units or ratio, for example, the time it takes light to travel between the tangible objects), one or more locations (e.g. specified using an agreed coordinate system, specified in relation to a known location), and more.

The LIDAR system may determine the distance between a pair of tangible objects based on reflected light. In one embodiment, the LIDAR system may process detection results of a sensor which creates temporal information indicative of a period of time between the emission of a light signal and the time of its detection by the sensor. The period of time is occasionally referred to as “time of flight” of the light signal. In one example, the light signal may be a short pulse, whose rise and/or fall time may be detected in reception. Using known information about the speed of light in the relevant medium (usually air), the information regarding the time of flight of the light signal can be processed to provide the distance the light signal traveled between emission and detection. In another embodiment, the LIDAR system may determine the distance based on frequency phase-shift (or multiple frequency phase-shift). Specifically, the LIDAR system may process information indicative of one or more modulation phase shifts (e.g. by solving some simultaneous equations to give a final measure) of the light signal. For example, the emitted optical signal may be modulated with one or more constant frequencies. The at least one phase shift of the modulation between the emitted signal and the detected reflection may be indicative of the distance the light traveled between emission and detection. The modulation may be applied to a continuous wave light signal, to a quasi-continuous wave light signal, or to another type of emitted light signal. It is noted that additional information may be used by the LIDAR system for determining the distance, e.g. location information (e.g. relative positions) between the projection location, the detection location of the signal (especially if distanced from one another), and more.

In some embodiments, the LIDAR system may be used for detecting a plurality of objects in an environment of the LIDAR system. The term “detecting an object in an environment of the LIDAR system” broadly includes generating information which is indicative of an object that reflected light toward a detector associated with the LIDAR system. If more than one object is detected by the LIDAR system, the generated information pertaining to different objects may be interconnected, for example a car is driving on a road, a bird is sitting on the tree, a man touches a bicycle, a van moves towards a building. The dimensions of the environment in which the LIDAR system detects objects may vary with respect to implementation. For example, the LIDAR system may be used for detecting a plurality of objects in an environment of a vehicle on which the LIDAR system is installed, up to a horizontal distance of 100 m (or 200 m, 300 m, etc.), and up to a vertical distance of 10 m (or 25 m, 50 m, etc.). In another example, the LIDAR system may be used for detecting a plurality of objects in an environment of a vehicle or within a predefined horizontal range (e.g., 25°, 50°, 100°, 180°, etc.), and up to a predefined vertical elevation (e.g., ±10°, ±20°, +40°−20°, ±90° or 0°−90°.

As used herein, the term “detecting an object” may broadly refer to determining an existence of the object (e.g., an object may exist in a certain direction with respect to the LIDAR system and/or to another reference location, or an object may exist in a certain spatial volume). Additionally or alternatively, the term “detecting an object” may refer to determining a distance between the object and another location (e.g. a location of the LIDAR system, a location on earth, or a location of another object). Additionally or alternatively, the term “detecting an object” may refer to identifying the object (e.g. classifying a type of object such as car, plant, tree, road; recognizing a specific object (e.g., the Washington Monument); determining a license plate number; determining a composition of an object (e.g., solid, liquid, transparent, semitransparent); determining a kinematic parameter of an object (e.g., whether it is moving, its velocity, its movement direction, expansion of the object). Additionally or alternatively, the term “detecting an object” may refer to generating a point cloud map in which every point of one or more points of the point cloud map correspond to a location in the object or a location on a face thereof. In one embodiment, the data resolution associated with the point cloud map representation of the field of view may be associated with 0.1°×0.1° or 0.3°×0.3° of the field of view.

Consistent with the present disclosure, the term “object” broadly includes a finite composition of matter that may reflect light from at least a portion thereof. For example, an object may be at least partially solid (e.g. cars, trees); at least partially liquid (e.g. puddles on the road, rain); at least partly gaseous (e.g. fumes, clouds); made from a multitude of distinct particles (e.g. sand storm, fog, spray); and may be of one or more scales of magnitude, such as ˜1 millimeter (mm), ˜5 mm, ˜10 mm, ˜50 mm, ˜100 mm, ˜500 mm, ˜1 meter (m), ˜5 m, ˜10 m, ˜50 m, ˜100 m, and so on. Smaller or larger objects, as well as any size in between those examples, may also be detected. It is noted that for various reasons, the LIDAR system may detect only part of the object. For example, in some cases, light may be reflected from only some sides of the object (e.g., only the side opposing the LIDAR system will be detected); in other cases, light may be projected on only part of the object (e.g. laser beam projected onto a road or a building); in other cases, the object may be partly blocked by another object between the LIDAR system and the detected object; in other cases, the LIDAR' s sensor may only detects light reflected from a portion of the object, e.g., because ambient light or other interferences interfere with detection of some portions of the object.

Consistent with the present disclosure, a LIDAR system may be configured to detect objects by scanning the environment of LIDAR system. The term “scanning the environment of LIDAR system” broadly includes illuminating the field of view or a portion of the field of view of the LIDAR system. In one example, scanning the environment of LIDAR system may be achieved by moving or pivoting a light deflector to deflect light in differing directions toward different parts of the field of view. In another example, scanning the environment of LIDAR system may be achieved by changing a positioning (i.e. location and/or orientation) of a sensor with respect to the field of view. In another example, scanning the environment of LIDAR system may be achieved by changing a positioning (i.e. location and/or orientation) of a light source with respect to the field of view. In yet another example, scanning the environment of LIDAR system may be achieved by changing the positions of at least one light source and of at least one sensor to move rigidly respect to the field of view (i.e. the relative distance and orientation of the at least one sensor and of the at least one light source remains).

As used herein the term “field of view of the LIDAR system” may broadly include an extent of the observable environment of LIDAR system in which objects may be detected. It is noted that the field of view (FOV) of the LIDAR system may be affected by various conditions such as but not limited to: an orientation of the LIDAR system (e.g. is the direction of an optical axis of the LIDAR system); a position of the LIDAR system with respect to the environment (e.g. distance above ground and adjacent topography and obstacles); operational parameters of the LIDAR system (e.g. emission power, computational settings, defined angles of operation), etc. The field of view of LIDAR system may be defined, for example, by a solid angle (e.g. defined using ϕ, θ angles, in which ϕ and θ are angles defined in perpendicular planes, e.g. with respect to symmetry axes of the LIDAR system and/or its FOV). In one example, the field of view may also be defined within a certain range (e.g. up to 200 m).

Similarly, the term “instantaneous field of view” may broadly include an extent of the observable environment in which objects may be detected by the LIDAR system at any given moment. For example, for a scanning LIDAR system, the instantaneous field of view is narrower than the entire FOV of the LIDAR system, and it can be moved within the FOV of the LIDAR system in order to enable detection in other parts of the FOV of the LIDAR system. The movement of the instantaneous field of view within the FOV of the LIDAR system may be achieved by moving a light deflector of the LIDAR system (or external to the LIDAR system), so as to deflect beams of light to and/or from the LIDAR system in differing directions. In one embodiment, LIDAR system may be configured to scan scene in the environment in which the LIDAR system is operating. As used herein the term “scene” may broadly include some or all of the objects within the field of view of the LIDAR system, in their relative positions and in their current states, within an operational duration of the LIDAR system. For example, the scene may include ground elements (e.g. earth, roads, grass, sidewalks, road surface marking), sky, man-made objects (e.g. vehicles, buildings, signs), vegetation, people, animals, light projecting elements (e.g. flashlights, sun, other LIDAR systems), and so on.

Any reference to the term “actuator” should be applied mutatis mutandis to the term “manipulator”. Non-limiting examples of manipulators include Micro-Electro-Mechanical Systems (MEMS) actuators, Voice Coil Magnets, motors, piezoelectric elements, and the like. It should be noted that a manipulator may be merged with a temperature control unit.

Disclosed embodiments may involve obtaining information for use in generating reconstructed three-dimensional models. Examples of types of reconstructed three-dimensional models which may be used include point cloud models, and Polygon Mesh (e.g. a triangle mesh). The terms “point cloud” and “point cloud model” are widely known in the art, and should be construed to include a set of data points located spatially in some coordinate system (i.e., having an identifiable location in a space described by a respective coordinate system).The term “point cloud point” refer to a point in space (which may be dimensionless, or a miniature cellular space, e.g. 1 cm3), and whose location may be described by the point cloud model using a set of coordinates (e.g. (X,Y,Z), (r,ϕ,θ)). By way of example only, the point cloud model may store additional information for some or all of its points (e.g. color information for points generated from camera images). Likewise, any other type of reconstructed three-dimensional model may store additional information for some or all of its objects. Similarly, the terms “polygon mesh” and “triangle mesh” are widely known in the art, and are to be construed to include, among other things, a set of vertices, edges and faces that define the shape of one or more 3D objects (such as a polyhedral object). The faces may include one or more of the following: triangles (triangle mesh), quadrilaterals, or other simple convex polygons, since this may simplify rendering. The faces may also include more general concave polygons, or polygons with holes. Polygon meshes may be represented using differing techniques, such as: Vertex-vertex meshes, Face-vertex meshes, Winged-edge meshes and Render dynamic meshes. Different portions of the polygon mesh (e.g., vertex, face, edge) are located spatially in some coordinate system (i.e., having an identifiable location in a space described by the respective coordinate system), either directly and/or relative to one another. The generation of the reconstructed three-dimensional model may be implemented using any standard, dedicated and/or novel photogrammetry technique, many of which are known in the art. It is noted that other types of models of the environment may be generated by the LIDAR system.

Consistent with disclosed embodiments, the LIDAR system may include at least one projecting unit with a light source configured to project light. As used herein the term “light source” broadly refers to any device configured to emit light. In one embodiment, the light source may be a laser such as a solid-state laser, laser diode, a high power laser, or an alternative light source such as, a light emitting diode (LED)-based light source. In addition, light source 112 as illustrated throughout the figures, may emit light in differing formats, such as light pulses, continuous wave (CW), quasi-CW, and so on. For example, one type of light source that may be used is a vertical-cavity surface-emitting laser (VCSEL). Another type of light source that may be used is an external cavity diode laser (ECDL). In some examples, the light source may include a laser diode configured to emit light at a wavelength between about 650 nm and 1150 nm. Alternatively, the light source may include a laser diode configured to emit light at a wavelength between about 800 nm and about 1000 nm, between about 850 nm and about 950 nm, or between about 1300 nm and about 1600 nm. Unless indicated otherwise, the term “about” with regards to a numeric value is defined as a variance of up to 5% with respect to the stated value. Additional details on the projecting unit and the at least one light source are described below with reference to FIGS. 2 and 3 of the current application and with reference to FIGS. 2A-2C of PCT patent application PCT/IB2020/055283 publication number WO2020/245767 which is incorporated herein by reference.

Consistent with disclosed embodiments, the LIDAR system may include at least one scanning unit with at least one light deflector configured to deflect light from the light source in order to scan the field of view. The term “light deflector” broadly includes any mechanism or module which is configured to make light deviate from its original path; for example, a minor, a prism, controllable lens, a mechanical minor, mechanical scanning polygons, active diffraction (e.g. controllable LCD), Risley prisms, non-mechanical-electro-optical beam steering (such as made by Vscent), polarization grating (such as offered by Boulder Non-Linear Systems), optical phased array (OPA), and more. In one embodiment, a light deflector may include a plurality of optical components, such as at least one reflecting element (e.g. a minor), at least one refracting element (e.g. a prism, a lens), and so on. In one example, the light deflector may be movable, to cause light deviate to differing degrees (e.g. discrete degrees, or over a continuous span of degrees). The light deflector may optionally be controllable in different ways (e.g. deflect to a degree α, change deflection angle by Δα, move a component of the light deflector by M millimeters, change speed in which the deflection angle changes). In addition, the light deflector may optionally be operable to change an angle of deflection within a single plane (e.g., θ coordinate). The light deflector may optionally be operable to change an angle of deflection within two non-parallel planes (e.g., θ and ϕ coordinates). Alternatively or in addition, the light deflector may optionally be operable to change an angle of deflection between predetermined settings (e.g. along a predefined scanning route) or otherwise. With respect the use of light deflectors in LIDAR systems, it is noted that a light deflector may be used in the outbound direction (also referred to as transmission direction, or TX) to deflect light from the light source to at least a part of the field of view. However, a light deflector may also be used in the inbound direction (also referred to as reception direction, or RX) to deflect light from at least a part of the field of view to one or more light sensors. Additional details on the scanning unit and the at least one light deflector are described below with reference to FIGS. 3A-3C of PCT patent application PCT/IB2020/055283 publication number WO2020/245767 which is incorporated herein by reference.

Disclosed embodiments may involve pivoting the light deflector in order to scan the field of view. As used herein the term “pivoting” broadly includes rotating of an object (especially a solid object) about one or more axis of rotation, while substantially maintaining a center of rotation fixed. In one embodiment, the pivoting of the light deflector may include rotation of the light deflector about a fixed axis (e.g., a shaft), but this is not necessarily so. For example, in some MEMS minor implementation, the MEMS mirror may move by actuation of a plurality of benders connected to the mirror, the minor may experience some spatial translation in addition to rotation. Nevertheless, such mirror may be designed to rotate about a substantially fixed axis, and therefore consistent with the present disclosure it considered to be pivoted. In other embodiments, some types of light deflectors (e.g. non-mechanical-electro-optical beam steering, OPA) do not require any moving components or internal movements in order to change the deflection angles of deflected light. It is noted that any discussion relating to moving or pivoting a light deflector is also mutatis mutandis applicable to controlling the light deflector such that it changes a deflection behavior of the light deflector. For example, controlling the light deflector may cause a change in a deflection angle of beams of light arriving from at least one direction.

Disclosed embodiments may involve receiving reflections associated with a portion of the field of view corresponding to a single instantaneous position of the light deflector. As used herein, the term “instantaneous position of the light deflector” (also referred to as “state of the light deflector”) broadly refers to the location or position in space where at least one controlled component of the light deflector is situated at an instantaneous point in time, or over a short span of time. In one embodiment, the instantaneous position of light deflector may be gauged with respect to a frame of reference. The frame of reference may pertain to at least one fixed point in the LIDAR system. Or, for example, the frame of reference may pertain to at least one fixed point in the scene. In some embodiments, the instantaneous position of the light deflector may include some movement of one or more components of the light deflector (e.g. minor, prism), usually to a limited degree with respect to the maximal degree of change during a scanning of the field of view. For example, a scanning of the entire the field of view of the LIDAR system may include changing deflection of light over a span of 30°, and the instantaneous position of the at least one light deflector may include angular shifts of the light deflector within 0.05°. In other embodiments, the term “instantaneous position of the light deflector” may refer to the positions of the light deflector during acquisition of light which is processed to provide data for a single point of a point cloud (or another type of 3D model) generated by the LIDAR system. In some embodiments, an instantaneous position of the light deflector may correspond with a fixed position or orientation in which the deflector pauses for a short time during illumination of a particular sub-region of the LIDAR field of view. In other cases, an instantaneous position of the light deflector may correspond with a certain position/orientation along a scanned range of positions/orientations of the light deflector that the light deflector passes through as part of a continuous or semi-continuous scan of the LIDAR field of view. In some embodiments, the light deflector may be moved such that during a scanning cycle of the LIDAR FOV the light deflector is located at a plurality of different instantaneous positions. In other words, during the period of time in which a scanning cycle occurs, the deflector may be moved through a series of different instantaneous positions/orientations, and the deflector may reach each different instantaneous position/orientation at a different time during the scanning cycle.

Consistent with disclosed embodiments, the LIDAR system may include at least one sensing unit with at least one sensor configured to detect reflections from objects in the field of view. The term “sensor” broadly includes any device, element, or system capable of measuring properties (e.g., power, frequency, phase, pulse timing, pulse duration) of electromagnetic waves and to generate an output relating to the measured properties. In some embodiments, the at least one sensor may include a plurality of detectors constructed from a plurality of detecting elements. The at least one sensor may include light sensors of one or more types. It is noted that the at least one sensor may include multiple sensors of the same type which may differ in other characteristics (e.g., sensitivity, size). Other types of sensors may also be used. Combinations of several types of sensors can be used for different reasons, such as improving detection over a span of ranges (especially in close range); improving the dynamic range of the sensor; improving the temporal response of the sensor; and improving detection in varying environmental conditions (e.g. atmospheric temperature, rain, etc.).

In one embodiment, the at least one sensor includes a SiPM (Silicon photomultipliers) which is a solid-state single-photon-sensitive device built from an array of avalanche photodiode (APD), single photon avalanche diode (SPAD), serving as detection elements on a common silicon substrate. In one example, a typical distance between SPADs may be between about 10 μm and about 50 μm, wherein each SPAD may have a recovery time of between about 20 ns and about 100 ns. Similar photomultipliers from other, non-silicon materials may also be used. Although a SiPM device works in digital/switching mode, the SiPM is an analog device because all the microcells may be read in parallel, making it possible to generate signals within a dynamic range from a single photon to hundreds and thousands of photons detected by the different SPADs. It is noted that outputs from different types of sensors (e.g., SPAD, APD, SiPM, PIN diode, Photodetector) may be combined together to a single output which may be processed by a processor of the LIDAR system. Additional details on the sensing unit and the at least one sensor are described below with reference to FIGS. 4 and 5 of the current application and with reference to FIGS. 4A-4C of PCT patent application PCT/IB2020/055283 publication number WO2020/245767 which is incorporated herein by reference.

Consistent with disclosed embodiments, the LIDAR system may include or communicate with at least one processor configured to execute differing functions. The at least one processor may constitute any physical device having an electric circuit that performs a logic operation on input or inputs. For example, the at least one processor may include one or more integrated circuits (IC), including Application-specific integrated circuit (ASIC), microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by at least one processor may, for example, be pre-loaded into a memory integrated with or embedded into the controller or may be stored in a separate memory. The memory may comprise a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the memory is configured to store information representative data about objects in the environment of the LIDAR system. In some embodiments, the at least one processor may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact. Additional details on the processing unit and the at least one processor are described below with reference to FIG. 6 of the current application and with reference to FIGS. 5A-5C of PCT patent application PCT/IB2020/055283 publication number WO2020/245767 which is incorporated herein by reference.

FIG. 1 illustrates a LIDAR system 100 including a projecting unit 102, a scanning unit 104, a sensing unit 106, and a processing unit 108. LIDAR system 100 may be mountable on a vehicle 110. Consistent with embodiments of the present disclosure, projecting unit 102 may include at least one light source 112, scanning unit 104 may include at least one light deflector 114, sensing unit 106 may include at least one sensor 116, and processing unit 108 may include at least one processor 118. In one embodiment, at least one processor 118 may be configured to coordinate operation of the at least one light source 112 with the movement of at least one light deflector 114 in order to scan a field of view 120. During a scanning cycle, each instantaneous position of at least one light deflector 114 may be associated with a particular portion 122 of field of view 120. In addition, LIDAR system 100 may include at least one optional optical window 124 for directing light projected towards field of view 120 and/or receiving light reflected from objects in field of view 120. Optional optical window 124 may serve different purposes, such as collimation of the projected light and focusing of the reflected light. In one embodiment, optional optical window 124 may be an opening, a flat window, a lens, or any other type of optical window.

Consistent with the present disclosure, LIDAR system 100 may be used in autonomous or semi-autonomous road-vehicles (for example, cars, buses, vans, trucks and any other terrestrial vehicle). Autonomous road-vehicles with LIDAR system 100 may scan their environment and drive to a destination vehicle without human input. Similarly, LIDAR system 100 may also be used in autonomous/semi-autonomous aerial-vehicles (for example, UAV, drones, quadcopters, and any other airborne vehicle or device); or in an autonomous or semi-autonomous water vessel (e.g., boat, ship, submarine, or any other watercraft). Autonomous aerial-vehicles and water craft with LIDAR system 100 may scan their environment and navigate to a destination autonomously or using a remote human operator. According to one embodiment, vehicle 110 (either a road-vehicle, aerial-vehicle, or watercraft) may use LIDAR system 100 to aid in detecting and scanning the environment in which vehicle 110 is operating.

It should be noted that LIDAR system 100 or any of its components may be used together with any of the example embodiments and methods disclosed herein. Further, while some aspects of LIDAR system 100 are described relative to an exemplary vehicle-based LIDAR platform, LIDAR system 100, any of its components, or any of the processes described herein may be applicable to LIDAR systems of other platform types.

In some embodiments, LIDAR system 100 may include one or more scanning units 104 to scan the environment around vehicle 110. LIDAR system 100 may be attached or mounted to any part of vehicle 110. Sensing unit 106 may receive reflections from the surroundings of vehicle 110, and transfer reflections signals indicative of light reflected from objects in field of view 120 to processing unit 108. Consistent with the present disclosure, scanning units 104 may be mounted to or incorporated into a bumper, a fender, a side panel, a spoiler, a roof, a headlight assembly, a taillight assembly, a rear-view mirror assembly, a hood, a trunk or any other suitable part of vehicle 110 capable of housing at least a portion of the LIDAR system. In some cases, LIDAR system 100 may capture a complete surround view of the environment of vehicle 110. Thus, LIDAR system 100 may have a 360-degree horizontal field of view. In one example, as shown in FIG. 1, LIDAR system 100 may include a single scanning unit 104 mounted on a roof vehicle 110. Alternatively, LIDAR system 100 may include multiple scanning units (e.g., two, three, four, or more scanning units 104) each with a field of few such that in the aggregate the horizontal field of view is covered by a 360-degree scan around vehicle 110. One skilled in the art will appreciate that LIDAR system 100 may include any number of scanning units 104 arranged in any manner, each with an 80° to 120° field of view or less, depending on the number of units employed. Moreover, a 360-degree horizontal field of view may be also obtained by mounting a multiple LIDAR systems 100 on vehicle 110, each with a single scanning unit 104. It is nevertheless noted that the one or more LIDAR systems 100 do not have to provide a complete 360° field of view, and that narrower fields of view may be useful in some situations. For example, vehicle 110 may require a first LIDAR system 100 having a field of view of 75° looking ahead of the vehicle, and possibly a second LIDAR system 100 with a similar FOV looking backward (optionally with a lower detection range). It is also noted that different vertical field of view angles may also be implemented.

### The Projecting Unit

FIGS. 2 and 3 depict various configurations of projecting unit 102 and its role in LIDAR system 100. Specifically, FIG. 2 is a diagram illustrating projecting unit 102 with a single light source; FIG. 3 is a diagram illustrating a plurality of projecting units 102 with a plurality of light sources aimed at a common light deflector 114. One skilled in the art will appreciate that the depicted configurations of projecting unit 102 may have numerous variations and modifications. Non limiting examples are provided in FIGS. 2C-2G of PCT patent application PCT/IB2020/055283 publication number WO2020/245767 which is incorporated herein by reference

FIG. 2 illustrates an example of a bi-static configuration of LIDAR system 100 in which projecting unit 102 includes a single light source 112. The term “bi-static configuration” broadly refers to LIDAR systems configurations in which the projected light exiting the LIDAR system and the reflected light entering the LIDAR system pass through substantially different optical paths. In some embodiments, a bi-static configuration of LIDAR system 100 may include a separation of the optical paths by using completely different optical components, by using parallel but not fully separated optical components, or by using the same optical components for only part of the of the optical paths (optical components may include, for example, windows, lenses, mirrors, beam splitters, etc.). In the example depicted in FIG. 2A, the bi-static configuration includes a configuration where the outbound light and the inbound light pass through a single optical window 124 but scanning unit 104 includes two light deflectors, a first light deflector 114A for outbound light and a second light deflector 114B for inbound light (the inbound light in LIDAR system includes emitted light reflected from objects in the scene, and may also include ambient light arriving from other sources).

In this embodiment, all the components of LIDAR system 100 may be contained within a single housing 200, or may be divided among a plurality of housings. As shown, projecting unit 102 is associated with a single light source 112 that includes a laser diode 202A (or one or more laser diodes coupled together) configured to emit light (projected light 204). In one non-limiting example, the light projected by light source 112 may be at a wavelength between about 800 nm and 950 nm, have an average power between about 50 mW and about 500 mW, have a peak power between about 50 W and about 200 W, and a pulse width of between about 2 ns and about 100 ns. In addition, light source 112 may optionally be associated with optical assembly 202B used for manipulation of the light emitted by laser diode 202A (e.g. for collimation, focusing, etc.). It is noted that other types of light sources 112 may be used, and that the disclosure is not restricted to laser diodes. In addition, light source 112 may emit its light in different formats, such as light pulses, frequency modulated, continuous wave (CW), quasi-CW, or any other form corresponding to the particular light source employed. The projection format and other parameters may be changed by the light source from time to time based on different factors, such as instructions from processing unit 108. The projected light is projected towards an outbound deflector 114A that functions as a steering element for directing the projected light in field of view 120. In this example, scanning unit 104 also include a pivotable return deflector 114B that direct photons (reflected light 206) reflected back from an object 208 within field of view 120 toward sensor 116. The reflected light is detected by sensor 116 and information about the object (e.g., the distance to object 212) is determined by processing unit 108.

In this figure, LIDAR system 100 is connected to a host 210. Consistent with the present disclosure, the term “host” refers to any computing environment that may interface with LIDAR system 100, it may be a vehicle system (e.g., part of vehicle 110), a testing system, a security system, a surveillance system, a traffic control system, an urban modelling system, or any system that monitors its surroundings. Such computing environment may include at least one processor and/or may be connected LIDAR system 100 via the cloud. In some embodiments, host 210 may also include interfaces to external devices such as camera and sensors configured to measure different characteristics of host 210 (e.g., acceleration, steering wheel deflection, reverse drive, etc.). Consistent with the present disclosure, LIDAR system 100 may be fixed to a stationary object associated with host 210 (e.g. a building, a tripod) or to a portable system associated with host 210 (e.g., a portable computer, a movie camera). Consistent with the present disclosure, LIDAR system 100 may be connected to host 210, to provide outputs of LIDAR system 100 (e.g., a 3D model, a reflectivity image) to host 210. Specifically, host 210 may use LIDAR system 100 to aid in detecting and scanning the environment of host 210 or any other environment. In addition, host 210 may integrate, synchronize or otherwise use together the outputs of LIDAR system 100 with outputs of other sensing systems (e.g. cameras, microphones, radar systems). In one example, LIDAR system 100 may be used by a security system.

LIDAR system 100 may also include a bus 212 (or other communication mechanisms) that interconnect subsystems and components for transferring information within LIDAR system 100. Optionally, bus 212 (or another communication mechanism) may be used for interconnecting LIDAR system 100 with host 210. In the example of FIG. 2A, processing unit 108 includes two processors 118 to regulate the operation of projecting unit 102, scanning unit 104, and sensing unit 106 in a coordinated manner based, at least partially, on information received from internal feedback of LIDAR system 100. In other words, processing unit 108 may be configured to dynamically operate LIDAR system 100 in a closed loop. A closed loop system is characterized by having feedback from at least one of the elements and updating one or more parameters based on the received feedback. Moreover, a closed loop system may receive feedback and update its own operation, at least partially, based on that feedback. A dynamic system or element is one that may be updated during operation.

According to some embodiments, scanning the environment around LIDAR system 100 may include illuminating field of view 120 with light pulses. The light pulses may have parameters such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. Scanning the environment around LIDAR system 100 may also include detecting and characterizing various aspects of the reflected light. Characteristics of the reflected light may include, for example: time-of-flight (i.e., time from emission until detection), instantaneous power (e.g., power signature), average power across entire return pulse, and photon distribution/signal over return pulse period. By comparing characteristics of a light pulse with characteristics of corresponding reflections, a distance and possibly a physical characteristic, such as reflected intensity of object 212 may be estimated. By repeating this process across multiple adjacent portions 122, in a predefined pattern (e.g., raster, Lissajous or other patterns) an entire scan of field of view 120 may be achieved. As discussed below in greater detail, in some situations LIDAR system 100 may direct light to only some of the portions 122 in field of view 120 at every scanning cycle. These portions may be adjacent to each other, but not necessarily so.

In another embodiment, LIDAR system 100 may include network interface 214 for communicating with host 210 (e.g., a vehicle controller). The communication between LIDAR system 100 and host 210 is represented by a dashed arrow. In one embodiment, network interface 214 may include an integrated services digital network (ISDN) card, cable modem, satellite modem, or a modem to provide a data communication connection to a corresponding type of telephone line. As another example, network interface 214 may include a local area network (LAN) card to provide a data communication connection to a compatible LAN. In another embodiment, network interface 214 may include an Ethernet port connected to radio frequency receivers and transmitters and/or optical (e.g., infrared) receivers and transmitters. The specific design and implementation of network interface 214 depends on the communications network(s) over which LIDAR system 100 and host 210 are intended to operate. For example, network interface 214 may be used, for example, to provide outputs of LIDAR system 100 to the external system, such as a 3D model, operational parameters of LIDAR system 100, and so on. In other embodiment, the communication unit may be used, for example, to receive instructions from the external system, to receive information regarding the inspected environment, to receive information from another sensor, etc.

FIG. 3 illustrates an example of a monostatic configuration of LIDAR system 100 including a plurality projecting units 102. The term “monostatic configuration” broadly refers to LIDAR system configurations in which the projected light exiting from the LIDAR system and the reflected light entering the LIDAR system pass through substantially similar optical paths. In one example, the outbound light beam and the inbound light beam may share at least one optical assembly through which both outbound and inbound light beams pass. In another example, the outbound light may pass through an optical window (not shown) and the inbound light radiation may pass through the same optical window. A monostatic configuration may include a configuration where the scanning unit 104 includes a single light deflector 114 that directs the projected light towards field of view 120 and directs the reflected light towards a sensor 116. As shown, both projected light 204 and reflected light 206 hits an asymmetrical deflector 216. The term “asymmetrical deflector” refers to any optical device having two sides capable of deflecting a beam of light hitting it from one side in a different direction than it deflects a beam of light hitting it from the second side. In one example, the asymmetrical deflector does not deflect projected light 204 and deflects reflected light 206 towards sensor 116. One example of an asymmetrical deflector may include a polarization beam splitter. In another example, asymmetrical 216 may include an optical isolator that allows the passage of light in only one direction. A diagrammatic representation of asymmetrical deflector 216 is illustrated in FIG. 2D. Consistent with the present disclosure, a monostatic configuration of LIDAR system 100 may include an asymmetrical deflector to prevent reflected light from hitting light source 112, and to direct all the reflected light toward sensor 116, thereby increasing detection sensitivity.

In the embodiment of FIG. 3, LIDAR system 100 includes three projecting units 102 each with a single of light source 112 aimed at a common light deflector 114. In one embodiment, the plurality of light sources 112 (including two or more light sources) may project light with substantially the same wavelength and each light source 112 is generally associated with a differing area of the field of view (denoted in the figure as 120A, 120B, and 120C). This enables scanning of a broader field of view than can be achieved with a light source 112. In another embodiment, the plurality of light sources 102 may project light with differing wavelengths, and all the light sources 112 may be directed to the same portion (or overlapping portions) of field of view 120.

### The Sensing Unit

FIGS. 5 and 6 depict various configurations of sensing unit 106 and its role in LIDAR system 100. Specifically, FIG. 5 is a diagram illustrating a lens array associated with sensor 116, and FIG. 6 includes three diagram illustrating the lens structure. One skilled in the art will appreciate that the depicted configurations of sensing unit 106 are exemplary only and may have numerous alternative variations and modifications consistent with the principles of this disclosure.

FIG. 4 is a cross cut diagram of a part of sensor 116, in accordance with examples of the presently disclosed subject matter. The illustrated part of sensor 116 includes a part of a detector array 400 which includes four detection elements 402 (e.g., four SPADs, four APDs). Detector array 400 may be a photodetector sensor realized in complementary metal—oxide—semiconductor (CMOS). Each of the detection elements 402 has a sensitive area, which is positioned within a substrate surrounding. While not necessarily so, sensor 116 may be used in a monostatic LIDAR system having a narrow field of view (e.g., because scanning unit 104 scans different parts of the field of view at different times). The narrow field of view for the incoming light beam—if implemented—eliminates the problem of out-of-focus imaging. As exemplified in FIG. 4, sensor 116 may include a plurality of lenses 422 (e.g., microlenses), each lens 422 may direct incident light toward a different detection element 402 (e.g., toward an active area of detection element 402), which may be usable when out-of-focus imaging is not an issue. Lenses 422 may be used for increasing an optical fill factor and sensitivity of detector array 400, because most of the light that reaches sensor 116 may be deflected toward the active areas of detection elements 402

Detector array 400, as exemplified in FIG. 4, may include several layers built into the silicon substrate by various methods (e.g., implant) resulting in a sensitive area, contact elements to the metal layers and isolation elements (e.g., shallow trench implant STI, guard rings, optical trenches, etc.). The sensitive area may be a volumetric element in the CMOS detector that enables the optical conversion of incoming photons into a current flow given an adequate voltage bias is applied to the device. In the case of an APD/SPAD, the sensitive area would be a combination of an electrical field that pulls electrons created by photon absorption towards a multiplication area where a photon induced electron is amplified creating a breakdown avalanche of multiplied electrons.

A front side illuminated detector (e.g., as illustrated in FIG. 4) has the input optical port at the same side as the metal layers residing on top of the semiconductor (Silicon). The metal layers are required to realize the electrical connections of each individual photodetector element (e.g., anode and cathode) with various elements such as: bias voltage, quenching/ballast elements, and other photodetectors in a common array. The optical port through which the photons impinge upon the detector sensitive area is comprised of a passage through the metal layer. It is noted that passage of light from some directions through this passage may be blocked by one or more metal layers (e.g., metal layer ML6, as illustrated for the leftmost detector elements 402 in FIG. 4). Such blockage reduces the total optical light absorbing efficiency of the detector.

FIG. 5 illustrates three detection elements 402, each with an associated lens 422, in accordance with examples of the presenting disclosed subject matter. Each of the three detection elements of FIG. 5, denoted 402(1), 402(2), and 402(3), illustrates a lens configuration which may be implemented in associated with one or more of the detecting elements 402 of sensor 116. It is noted that combinations of these lens configurations may also be implemented.

In the lens configuration illustrated with regards to detection element 402(1), a focal point of the associated lens 422 may be located above the semiconductor surface. Optionally, openings in different metal layers of the detection element may have different sizes aligned with the cone of focusing light generated by the associated lens 422. Such a structure may improve the signal-to-noise and resolution of the array 400 as a whole device. Large metal layers may be important for delivery of power and ground shielding. This approach may be useful, e.g., with a monostatic LIDAR design with a narrow field of view where the incoming light beam is comprised of parallel rays and the imaging focus does not have any consequence to the detected signal.

In the lens configuration illustrated with regards to detection element 402(2), an efficiency of photon detection by the detection elements 402 may be improved by identifying a sweet spot. Specifically, a photodetector implemented in CMOS may have a sweet spot in the sensitive volume area where the probability of a photon creating an avalanche effect is the highest. Therefore, a focal point of lens 422 may be positioned inside the sensitive volume area at the sweet spot location, as demonstrated by detection elements 402(2). The lens shape and distance from the focal point may take into account the refractive indices of all the elements the laser beam is passing along the way from the lens to the sensitive sweet spot location buried in the semiconductor material.

In the lens configuration illustrated with regards to the detection element on the right of FIG. 5, an efficiency of photon absorption in the semiconductor material may be improved using a diffuser and reflective elements. Specifically, a near IR wavelength requires a significantly long path of silicon material in order to achieve a high probability of absorbing a photon that travels through. In a typical lens configuration, a photon may traverse the sensitive area and may not be absorbed into a detectable electron. A long absorption path that improves the probability for a photon to create an electron renders the size of the sensitive area towards less practical dimensions (tens of um for example) for a CMOS device fabricated with typical foundry processes. The rightmost detector element in FIG. 5 demonstrates a technique for processing incoming photons. The associated lens 422 focuses the incoming light onto a diffuser element 424. In one embodiment, light sensor 116 may further include a diffuser located in the gap distant from the outer surface of at least some of the detectors. For example, diffuser 424 may steer the light beam sideways (e.g., as perpendicular as possible) towards the sensitive area and the reflective optical trenches 426. The diffuser is located at the focal point, above the focal point, or below the focal point. In this embodiment, the incoming light may be focused on a specific location where a diffuser element is located. Optionally, detector element 422 is designed to optically avoid the inactive areas where a photon induced electron may get lost and reduce the effective detection efficiency. Reflective optical trenches 426 (or other forms of optically reflective structures) cause the photons to bounce back and forth across the sensitive area, thus increasing the likelihood of detection. Ideally, the photons will get trapped in a cavity consisting of the sensitive area and the reflective trenches indefinitely until the photon is absorbed and creates an electron/hole pair.

Consistent with the present disclosure, a long path is created for the impinging photons to be absorbed and contribute to a higher probability of detection. Optical trenches may also be implemented in detecting element 422 for reducing cross talk effects of parasitic photons created during an avalanche that may leak to other detectors and cause false detection events. According to some embodiments, a photo detector array may be optimized so that a higher yield of the received signal is utilized, meaning, that as much of the received signal is received and less of the signal is lost to internal degradation of the signal. The photo detector array may be improved by: (a) moving the focal point at a location above the semiconductor surface, optionally by designing the metal layers above the substrate appropriately; (b) by steering the focal point to the most responsive/sensitive area (or “sweet spot”) of the substrate and (c) adding a diffuser above the substrate to steer the signal toward the “sweet spot” and/or adding reflective material to the trenches so that deflected signals are reflected back to the “sweet spot.”

While in some lens configurations, lens 422 may be positioned so that its focal point is above a center of the corresponding detection element 402, it is noted that this is not necessarily so. In other lens configuration, a position of the focal point of the lens 422 with respect to a center of the corresponding detection element 402 is shifted based on a distance of the respective detection element 402 from a center of the detection array 400. This may be useful in relatively larger detection arrays 400, in which detector elements further from the center receive light in angles which are increasingly off-axis. Shifting the location of the focal points (e.g., toward the center of detection array 400) allows correcting for the incidence angles. Specifically, shifting the location of the focal points (e.g., toward the center of detection array 400) allows correcting for the incidence angles while using substantially identical lenses 422 for all detection elements, which are positioned at the same angle with respect to a surface of the detector.

Adding an array of lenses 422 to an array of detection elements 402 may be useful when using a relatively small sensor 116 which covers only a small part of the field of view because in such a case, the reflection signals from the scene reach the detectors array 400 from substantially the same angle, and it is, therefore, easy to focus all the light onto individual detectors. It is also noted, that in one embodiment, lenses 422 may be used in LIDAR system 100 for favoring about increasing the overall probability of detection of the entire array 400 (preventing photons from being “wasted” in the dead area between detectors/sub-detectors) at the expense of spatial distinctiveness. This embodiment is in contrast to prior art implementations such as CMOS RGB camera, which prioritize spatial distinctiveness (i.e., light that propagates in the direction of detection element A is not allowed to be directed by the lens toward detection element B, that is, to “bleed” to another detection element of the array). Optionally, sensor 116 includes an array of lens 422, each being correlated to a corresponding detection element 402, while at least one of the lenses 422 deflects light which propagates to a first detection element 402 toward a second detection element 402 (thereby it may increase the overall probability of detection of the entire array).

Specifically, consistent with some embodiments of the present disclosure, light sensor 116 may include an array of light detectors (e.g., detector array 400), each light detector (e.g., detector 410) being configured to cause an electric current to flow when light passes through an outer surface of a respective detector. In addition, light sensor 116 may include at least one micro-lens configured to direct light toward the array of light detectors, the at least one micro-lens having a focal point. Light sensor 116 may further include at least one layer of conductive material interposed between the at least one micro-lens and the array of light detectors and having a gap therein to permit light to pass from the at least one micro-lens to the array, the at least one layer being sized to maintain a space between the at least one micro-lens and the array to cause the focal point (e.g., the focal point may be a plane) to be located in the gap, at a location spaced from the detecting surfaces of the array of light detectors.

In related embodiments, each detector may include a plurality of Single Photon Avalanche Diodes (SPADs) or a plurality of Avalanche Photo Diodes (APD). The conductive material may be a multi-layer metal constriction, and the at least one layer of conductive material may be electrically connected to detectors in the array. In one example, the at least one layer of conductive material includes a plurality of layers. In addition, the gap may be shaped to converge from the at least one micro-lens toward the focal point, and to diverge from a region of the focal point toward the array. In other embodiments, light sensor 116 may further include at least one reflector adjacent each photo detector. In one embodiment, a plurality of micro-lenses may be arranged in a lens array and the plurality of detectors may be arranged in a detector array. In another embodiment, the plurality of micro-lenses may include a single lens configured to project light to a plurality of detectors in the array.

### The Processing Unit

FIG. 5 illustrates four examples of emission patterns in a single frame-time for a single portion 122 of field of view 120 associated with an instantaneous position of at least one light deflector 114. Consistent with embodiments of the present disclosure, processing unit 108 may control at least one light source 112 and light deflector 114 (or coordinate the operation of at least one light source 112 and at least one light deflector 114) in a manner enabling light flux to vary over a scan of field of view 120. Consistent with other embodiments, processing unit 108 may control only at least one light source 112 and light deflector 114 may be moved or pivoted in a fixed predefined pattern.

Diagrams A-D in FIG. 5 depict the power of light emitted towards a single portion 122 of field of view 120 over time. In Diagram A, processor 118 may control the operation of light source 112 in a manner such that during scanning of field of view 120 an initial light emission is projected toward portion 122 of field of view 120. When projecting unit 102 includes a pulsed-light light source, the initial light emission may include one or more initial pulses (also referred to as “pilot pulses”). Processing unit 108 may receive from sensor 116 pilot information about reflections associated with the initial light emission. In one embodiment, the pilot information may be represented as a single signal based on the outputs of one or more detectors (e.g. one or more SPADs, one or more APDs, one or more SiPMs, etc.) or as a plurality of signals based on the outputs of multiple detectors. In one example, the pilot information may include analog and/or digital information. In another example, the pilot information may include a single value and/or a plurality of values (e.g. for different times and/or parts of the segment).

Based on information about reflections associated with the initial light emission, processing unit 108 may be configured to determine the type of subsequent light emission to be projected towards portion 122 of field of view 120. The determined subsequent light emission for the particular portion of field of view 120 may be made during the same scanning cycle (i.e., in the same frame) or in a subsequent scanning cycle (i.e., in a subsequent frame).

In Diagram B, processor 118 may control the operation of light source 112 in a manner such that during scanning of field of view 120 light pulses in different intensities are projected towards a single portion 122 of field of view 120. In one embodiment, LIDAR system 100 may be operable to generate depth maps of one or more different types, such as any one or more of the following types: point cloud model, polygon mesh, depth image (holding depth information for each pixel of an image or of a 2D array), or any other type of 3D model of a scene. The sequence of depth maps may be a temporal sequence, in which different depth maps are generated at a different time. Each depth map of the sequence associated with a scanning cycle (interchangeably “frame”) may be generated within the duration of a corresponding subsequent frame-time. In one example, a typical frame-time may last less than a second. In some embodiments, LIDAR system 100 may have a fixed frame rate (e.g. 10 frames per second, 25 frames per second, 50 frames per second) or the frame rate may be dynamic. In other embodiments, the frame-times of different frames may not be identical across the sequence. For example, LIDAR system 100 may implement a 10 frames-per-second rate that includes generating a first depth map in 100 milliseconds (the average), a second frame in 92 milliseconds, a third frame at 142 milliseconds, and so on.

In Diagram C, processor 118 may control the operation of light source 112 in a manner such that during scanning of field of view 120 light pulses associated with different durations are projected towards a single portion 122 of field of view 120. In one embodiment, LIDAR system 100 may be operable to generate a different number of pulses in each frame. The number of pulses may vary between 0 to 32 pulses (e.g., 1, 5, 12, 28, or more pulses) and may be based on information derived from previous emissions. The time between light pulses may depend on desired detection range and can be between 500 ns and 5000 ns. In one example, processing unit 108 may receive from sensor 116 information about reflections associated with each light-pulse. Based on the information (or the lack of information), processing unit 108 may determine if additional light pulses are needed. It is noted that the durations of the processing times and the emission times in diagrams A-D are not in-scale. Specifically, the processing time may be substantially longer than the emission time. In diagram D, projecting unit 102 may include a continuous-wave light source. In one embodiment, the initial light emission may include a period of time where light is emitted and the subsequent emission may be a continuation of the initial emission, or there may be a discontinuity. In one embodiment, the intensity of the continuous emission may change over time.

Consistent with some embodiments of the present disclosure, the emission pattern may be determined per each portion of field of view 120. In other words, processor 118 may control the emission of light to allow differentiation in the illumination of different portions of field of view 120. In one example, processor 118 may determine the emission pattern for a single portion 122 of field of view 120, based on detection of reflected light from the same scanning cycle (e.g., the initial emission), which makes LIDAR system 100 extremely dynamic. In another example, processor 118 may determine the emission pattern for a single portion 122 of field of view 120, based on detection of reflected light from a previous scanning cycle. The differences in the patterns of the subsequent emissions may result from determining different values for light-source parameters for the subsequent emission, such as any one of the following.
a. Overall energy of the subsequent emission.
b. Energy profile of the subsequent emission.
c. A number of light-pulse-repetition per frame.
d. Light modulation characteristics such as duration, rate, peak, average power, and pulse shape.
e. Wave properties of the subsequent emission, such as polarization, wavelength, etc.

Consistent with the present disclosure, the differentiation in the subsequent emissions may be put to different uses. In one example, it is possible to limit emitted power levels in one portion of field of view 120 where safety is a consideration, while emitting higher power levels (thus improving signal-to-noise ratio and detection range) for other portions of field of view 120. This is relevant for eye safety, but may also be relevant for skin safety, safety of optical systems, safety of sensitive materials, and more. In another example, it is possible to direct more energy towards portions of field of view 120 where it will be of greater use (e.g. regions of interest, further distanced targets, low reflection targets, etc.) while limiting the lighting energy to other portions of field of view 120 based on detection results from the same frame or previous frame. It is noted that processing unit 108 may process detected signals from a single instantaneous field of view several times within a single scanning frame time; for example, subsequent emission may be determined upon after every pulse emitted, or after a number of pulses emitted.

It should be noted that while examples of various disclosed embodiments have been described above and below with respect to a control unit that controls scanning of a deflector, the various features of the disclosed embodiments are not limited to such systems. Rather, the techniques for allocating light to various portions of a LIDAR FOV may be applicable to type of light-based sensing system (LIDAR or otherwise) in which there may be a desire or need to direct different amounts of light to different portions of field of view. In some cases, such light allocation techniques may positively impact detection capabilities, as described herein, but other advantages may also result. It should also be noted that various sections of the disclosure and the claims may refer to various components or portions of components (e.g., light sources, sensors, sensor pixels, field of view portions, field of view pixels, etc.) using such terms as “first,” “second,” “third,” etc. These terms are used only to facilitate the description of the various disclosed embodiments and are not intended to be limiting or to indicate any necessary correlation with similarly named elements or components in other embodiments. For example, characteristics described as associated with a “first sensor” in one described embodiment in one section of the disclosure may or may not be associated with a “first sensor” of a different embodiment described in a different section of the disclosure. It is noted that LIDAR system 100, or any of its components, may be used together with any of the particular embodiments and methods disclosed below. Nevertheless, the particular embodiments and methods disclosed below are not necessarily limited to LIDAR system 100, and may possibly be implemented in or by other systems (such as but not limited to other LIDAR systems, other electrooptical systems, other optical systems, etc.—whichever is applicable). Also, while system 100 is described relative to an exemplary vehicle-based LIDAR platform, system 100, any of its components, and any of the processes described herein may be applicable to LIDAR systems disposed on other platform types. Likewise, the embodiments and processes disclosed below may be implemented on or by LIDAR systems (or other systems such as other elecrooptical systems etc.) which are installed on systems disposed on platforms other than vehicles, or even regardless of any specific platform.

### Detecting Obstructions

In a LIDAR system consistent with embodiments of the present disclosure, obstructions on a window through which the LIDAR system transmits light and/or receives light may block (or partially block) light passage through the window. The window may be an optical window such as optical window 124 of FIG. 1 or may be a dedicated protective window provided in addition to optical window 124—for example protective window 1010 of FIG. 7A. Alternatively, the window may be any window through which the LIDAR system transmitted light must pass before reaching the field of view (FOV). For example, a LIDAR mounted in a vehicle transmits light through a vehicle window towards a FOV. In the following text, any reference to a window should be applied mutatis mutandis on an optical window and/or on a dedicated protective window.

For example, the vehicle may come in contact with salt, mud, road grime, snow, rain, dust, bug debris, pollen, and bird droppings (among other things) which may block light from passing through the window of the system. Such blockages of light may be complete or partial. For example, in some cases, the blockage may be substantially opaque or, alternatively, may be translucent or semi-transparent and may allow at least some light to pass. In some cases, the blockage may limit an amount of incident light through refraction of light (e.g., especially away from an intended light reception path or away from relevant sensors). In such cases, the blockage may even be transparent. Additionally, a blockage may occur only over a portion of the window relevant to the system or may be more widespread. In some embodiments, discussed in detail below, a type of obstruction may be determined, and one or more remedial actions may be taken. For example, in some cases, an obstruction pattern may be detected by the system, and based on this pattern, the system may classify the obstruction and implement a process for cleaning the obstruction based on the classification. For example, based on the detection and/or classification of the obstruction pattern, the system may modify an illumination scheme, a scanning scheme, a detection scheme or any other operational parameters of the system based on the results of the analysis of the obstruction. According to an embodiment, the detection of the obstruction of a window of the LIDAR system is based, at least in part, on processing detection signals generated by an obstruction sensor. There may be more than a single obstruction sensor. Any reference to an obstruction sensor should be applied mutatis mutandis to obstruction sensors.

The obstruction sensor differs from an object related sensor of the LIDAR system that is associated with a detection one or more objects within a field of view (FOV) of the LIDAR system. The object related sensor is associated with the detection in the sense that the object related sensor generates detection signals that are processed to detect the one or more objects within the FOV. An example of an object related sensor is the sensing unit 16 of FIG. 1.

According to an embodiment, the obstruction sensor generates detection signals when there is enough ambient light—even without having the window illuminated by the LIDAR system. What amounts to “enough” light may be determined in any manner, For example—enough light is the amount of light that allows to provides an accurate (by at least a certain level of accuracy—also to be defined in any manner) detection of an obstruction. If there is not enough light—then the detection of the obstruction may be based on an illumination of the window.

The obstruction sensor may be an image sensor. The detection signals generated by the obstruction sensor may be an image, a sequence of images, and the like.

According to an embodiment, the obstruction sensor generates detection signals when the window is illuminated by the LIDAR.

According to an embodiment, the window is illuminated by light transmitted by the LIDAR system in relation to the detection of one or more objects (for example—the light transmitted by the LIDAR projecting unit 102 and scanned by LIDAR scanning unit 104). In this case the obstruction sensor may be activated while at least a part of the window is illuminated. This type of illumination may instantaneously illuminate a portion of the window.

According to an embodiment, the window is illuminated by one or more obstruction illumination sources that differ from one or more objects related illumination sources configured to transmit light in relation to the detection of the one or more objects. An example of one or more obstruction illumination sources is provided in FIG. 10. The one or more illumination sources may be positioned to illuminate the window from one or more directions.

The obstruction sensor may have a depth of field defined to image the window region sharply, but ignore regions beyond the window in order to distinguish between blockages and objects near the window, but not on the surface of the window.

According to an embodiment, the obstruction sensor has a depth of field (DOF) near limit and a DOF far limit, wherein the window is positioned between the DOF near limit and the DOF far limit, and wherein the DOF far limit is in proximity to the window. For example—a distance between the window and the DOF far limit does not exceed 15 centimeters, and may be between 5 and 15 centimeters, or up to 25 cm. The DOF far limit should be in proximity to the window—so that the obstruction sensor will not sense one or more objects that are not obstructions on the window.

According to an embodiment, the DOF of the obstruction sensor differs than a DOF of the object related sensor.

FIG. 7A illustrates a LIDAR system that differs from the LIDAR system of FIG. 1 by including a protective window 1010 for protecting the optical window 124, and also includes an obstruction sensor 11 for sensing light scatterer or reflected from an obstruction located at the exterior of the protective window 1010.

FIG. 7B illustrates a LIDAR system that differs from the LIDAR system of FIG. 1 by including an obstruction sensor 11 for sensing light scattered or reflected from an obstruction located at the exterior of the optical window 124.

The obstruction sensor 11 may be required because the window is located in the near field of the LIDAR—and the transmitted radiation pattern formed by the laser beam from the LIDAR may be relatively large on the window relative to their size in the far field—and a finer resolution of obstruction detection is required.

The obstruction sensor 11 may have a field of view (FOV 12) that covers the entire window—or at least a majority (for example at least 70%, 80%, 90%) of the window.

The obstruction sensor 11 may include multiple pixels—whereas each pixel may cover an area of the window that has a sub-millimetric dimension, a millimetric scale dimension of the window—or a centimetric scale dimension (usually up to 1, 2, 3 centimeters) of the window. The resolution of the obstruction sensor may be fine enough to distinguish between different obstructions. For example—assuming that a water drop has a typical diameter of 1-2 mm, a splash of mud could have a length that exceeds 1 centimeter—than the obstruction sensor may have a millimetric or sub-millimetric resolution.

The obstruction sensor 11 should be located outside the optical path of the laser transmitter by the LIDAR system and should not reduce the detection capabilities of the LIDAR system—should be located outside the optical path of the sensing unit (such as a sensing unit 106 used to detect objects within the FOV of the LIDAR system).

The obstruction sensor 11 may have a fixed exposure time or an adaptable exposure time.

According to an embodiment the adaptable exposure time may be used to adapt the imaging parameters such as exposure time and contrast of an image (or any other detection signals generated by the obstruction sensor) to optimize the captured signal to noise (SNR). When it is determined that the SNR of an image is not high enough (below a predefined value)—the exposure time may be increased. This determination may be based on image processing and/or on other information such as the time of day, amount of ambient radiation, and the like.

According to an embodiment, the adaptable exposure time is used when the image (or any other detection signals generated by the obstruction sensor) is acquired based on an illumination of the window that involves scanning the window—for example—when the window is scanned by light transmitted by the LIDAR system in relation to the detection of one or more objects (for example—the light transmitted by the LIDAR projecting unit 102 and scanned by LIDAR scanning unit 104). In this case the exposure time is set to cover a scanning of the entire window or a part of the window (for example a scanning of a row of a window, scanning one or more cells of the window, and the like).

The exposure time may correlate to time required to illuminate various portions of the window 1010 at different resolutions. For example, the exposure time may be the time required to capture a single pixel measurement, a row or column in a frame, or an entire frame. The exposure time may vary from 20 nanoseconds (or from 1 microsecond) to 100, 150 or 200 microseconds. The exposure time may be pre-defined for a system, or may be adaptive.

When using an obstruction illumination source the obstruction sensor may be less sensitive to ambient radiation—for example it may be more sensitive to radiation having a wavelength of 940 nanometer.

The obstruction sensor 11 may be sensitive to radiation in any range. It may be beneficial to have an obstruction sensor that is sensitive to wavelength regions that found less in ambient light sources. For example, the obstruction sensor may be sensitive to light with a wavelength of 940 nm, which has a lower irradiance in sunlight due to atmospheric absorption. The obstruction illumination source may emit light at 940 nm. The obstruction sensor 11 may be sensitive to radiation at 905 nm, or in a range between 900 and 920 nm. The obstruction sensor may be sensitive to the wavelength of radiation emitted by the LIDAR system illumination source.

The obstruction sensor 11 may be enclosed in a light shield to prevent stray light in the system from reaching the sensor.

FIG. 8 illustrates an example of a LIDAR system that includes a LIDAR scanning unit 104, a LIDAR projecting unit 102, a LIDAR processing unit 108, a LIDAR sensing unit (as in FIG. 1), as well as obstruction sensor 11 and obstruction processing unit 118—that processes the signals from the obstruction sensor 11 to determine a presence of an obstruction.

FIG. 8 also illustrates a laser beam 51 that impinges on obstruction 61—whereas radiation 52 is reflected from the obstruction and impinges on obstruction sensor 11.

FIG. 8 illustrates an image 62 generated by obstruction sensor 11—which illustrates the obstruction sensor 11 as falling on few pixels.

It should be noted that different types of images acquisitions may impact the manner in which the obstruction is sensed by the obstruction sensor. The obstruction may be darker than its surroundings when the illumination is ambient light. The obstruction may be brighter than its surroundings when the illumination source is located within the LIDAR system.

FIG. 9 illustrates an example of a LIDAR system that includes a LIDAR scanning unit 104, a LIDAR projecting unit 102, a LIDAR processing unit 108, a LIDAR sensing unit (as in FIG. 1), as well as obstruction sensor 11 and obstruction processing unit 118—that includes a signal processing module 126, an obstruction classification module 128 and an obstruction cleaning module 130. Examples of an obstruction processing unit 118 are illustrated in US patent application 2020/0292679 which is incorporated herein by reference.

The signal processing module 126 may be an image processing module, analyzing the images obtained over a defined exposure time to identify obstructions. The image processing module may use classical computer vision image analysis algorithms, machine learning techniques, or a combination of both.

The obstruction sensor 11 may image the window 124, or an active area on the window 124. Areas through which LIDAR illumination is emitted are considered active areas. Areas that are not active areas do not impact the LIDAR function when they are blocked by an obstruction. The LIDAR system may be configured not to allocated resources for detecting of obscured non active areas—for example—image information about inactive areas may not be processed to detect obstructions.

It should be noted that the obstruction sensor may be configured to follow the scanning patters of the scanning unit (may be registers—in the sense of being in spatial synchronization with).

It should be noted that the obstruction sensor may sense radiation resulting from the emission of the laser of the LIDAR system—but that the detection of the obstruction may be assisted by having a dedicated radiation source—such as an obstruction illumination source (in addition to the transmitter of the LIDAR system that transmit light in relation to the detection of one or more objects within the FOV of the LIDAR system). The obstruction sensor 11 may detect ambient light transmitted through the window. There may be provided multiple illumination module—allocated to different areas of the window and/or for generating illumination beams of different wavelengths and/or of different sizes—the different sizes may provide different resolutions of obstruction detection.

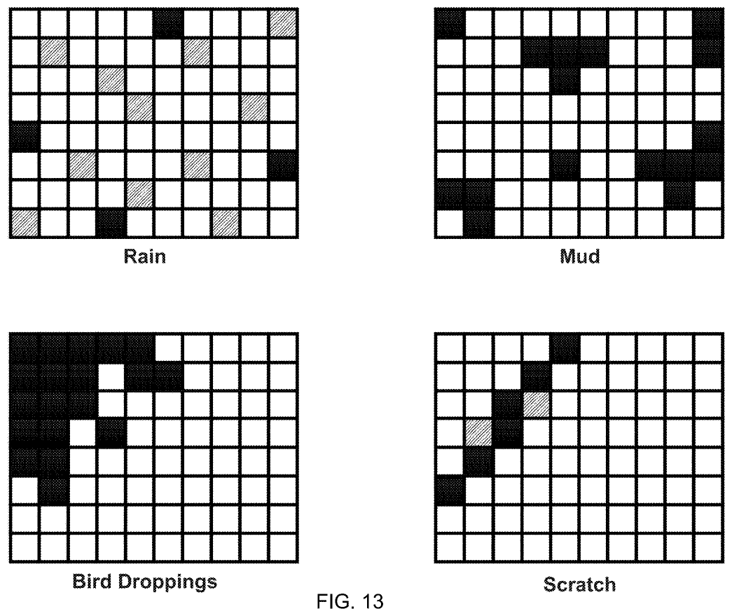

FIG. 10 illustrates an example of a LIDAR system. FIG. 13 also illustrates two different examples of an obstruction illumination source 13 for illuminating the window in order to detect any obstruction. The LIDAR system may include only one of the examples of the obstruction illumination source—or may include both examples of the obstruction illumination source. One of the examples of the obstruction illumination source includes a total internal reflection (TIR) illumination module. The obstruction illumination source 13 may scan the window (by scanning optics and/or my a motorized unit that moves the obstruction illumination source or any other optical component associated with the obstruction illumination source) or may illuminate a large enough area to illuminate the entire window or a significant part thereof.

The illumination module may include one or more light emitting diodes (LEDs).

The illumination module may operate at wavelengths that differ from those of the laser, at the same wavelengths, at wavelength regions that differ from ambient (for example solar) radiation—for example operate at about 940 nanometer, and the like.

The object detection and the obstruction detection may be executed at different points of time.
a. The illumination module may illuminate the window at times between the LIDAR illumination frames—to reduce interference between the LIDAR scanning and the obstruction detection process—as can be seen in FIG. 11—obstruction illumination periods 82 are between LIDAR illumination periods 81.
b. The object related sensor generates detection signals during one or more objects detection periods of time. An object detection period of time equals a LIDAR illumination frame—or may slightly extend until the end of a reception of light reflected from the last transmission during the LIDAR illumination frame.
c. The obstruction sensor generates detection signals during one or more obstruction detection periods of time. An obstruction detection period of time equals an obstruction illumination LIDAR illumination frame—or may slightly extend till the end of a reception of light reflected from the last transmission during the LIDAR illumination frame.
d. The obstruction sensor may generate detection signals without using any illumination. It is beneficial that these detection signals are generated when there is no LIDAR system transmission—for example outside the LIDAR illumination frame.

FIGS. 11-14 illustrate examples of classifications of obstructions. Examples of classifications are illustrated in US patent application 2020/0292679 which is incorporated herein by reference. While US patent application 2020/0292679 uses sensing unit 106—the current embodiment uses a dedicated sensing unit 11. Any reference in US patent application 2020/0292679 to the sensing unit of the LIDAR (TOF detection) should be applied mutatis mutandis to obstruction sensor 11.

FIG. 15 illustrates an example of a flow chart of a method that includes step 1201 of controlling at least one radiation source—LIDAR radiation source (used for TOF detection of objects)—or another (see illumination module 13). Step 1201 may be followed by step 1202 of receiving reflection signals from at least one obstruction sensor (for example an obstruction sensor that is an image sensor). Step 1202 may be followed by the following steps: (i) step 1203, in which a processor may detect a particular obstruction pattern at least partially obstructing light passing through the window of the system 1000, (ii) step 1204 in which the processor may access stored information characterizing reference obstruction patterns for at least one of salt, mud, road grime, snow, rain, dust, bug debris, pollen, and bird droppings, (iii) step 1205 in which the processor may compare the detected obstruction pattern with the reference obstruction patterns in order to determine a likely obstruction-pattern match, and (iv) step 1206 in which the processor may output information indicative of the match based on the likely match.

FIG. 16 illustrates an example of method 1600 for detecting an obstruction formed on a window associated with a LIDAR system.

According to an embodiment, method 1600 includes step 1610 of receiving, by at least one processor associated with the LIDAR system, detection signals generated by an obstruction sensor of the LIDAR system. The obstruction sensor differs from an object related sensor of the LIDAR system that is configured to detect one or more objects within a field of view (FOV) of the LIDAR system.

The at least one processor that is associated with the LIDAR system may belong to the LIDAR system or may not belong to the LIDAR system (i.e. be an external processor) but receive signals generated by the LIDAR system and/or may impact the operation of the LIDAR system in any manner.

According to an embodiment, step 1610 is followed by step 1620 of detecting the obstruction, by the at least one processor, based on the detection signals generated by an obstruction sensor of the LIDAR system. The obstruction at least partially obstructs a passage of light through the window.

FIG. 17 illustrates an example of method 1700 for obtaining detection signals generated by an obstruction sensor of the LIDAR system.

According to an embodiment, method 1700 includes step 1720 of generating detection signals by an obstruction sensor of a LIDAR system. The obstruction sensor differs from an object related sensor of the LIDAR system that is configured to detect one or more objects within a field of view (FOV) of the LIDAR system. The detection signals are indicative of whether there is an obstruction that is formed on the window associated with a LIDAR system. The obstruction at least partially obstructs a passage of light through the window.

According to an embodiment, step 1720 is preceded by step 1710 of illuminating the window. The window may be illuminated by one or more obstruction illumination sources and/or by light transmitted by the LIDAR system in relation to the detection of one or more objects.

According to an embodiment, step 1720 is preceded by determining that there is enough ambient light to acquire the detection signals.

According to an embodiment, step 1720 includes detecting the obstruction while ignoring detection signals generated by the object related sensor.

According to an embodiment, step 1720 includes detecting the one or more objects while ignoring detection signals generated by the obstruction sensor.

According to an embodiment, method 1720 includes receiving, by at least one processor, the detection signals generated by the obstruction sensor during one or more obstruction detection periods of time, and (ii) receiving detection signals generated by the object related sensor during one or more objects detection periods of time, wherein the one or more obstruction detection periods of time do not overlap the one or more objects detection periods of time.

According to an embodiment, a resolution of the obstruction sensor is smaller than an area of the window that is instantaneously illuminated by a transmission of light by the LIDAR system during an objects detection period of time.

According to an embodiment, the method includes adjusting an adjustable exposure period of the obstruction sensor.

According to an embodiment, the method includes determining the duration of the adjustable exposure period based on a duration of a scanning of the FOV of the LIDAR system.

According to an embodiment, the method includes determining the duration of the adjustable exposure period based on a desired coverage of the window.

According to an embodiment, the obstruction sensor has a first sensitivity to solar radiation and a second sensitivity to radiation generated by the LIDAR that illuminates the window, wherein the first sensitivity is lower than the second sensitivity.

According to an embodiment, the obstruction sensor is insensitive to a light transmitted by the LIDAR system in relation to the detection of one or more objects.

According to an embodiment, the obstruction sensor is sensitive to a light transmitted by the LIDAR system in relation to the detection of one or more objects.

According to an embodiment, the detection signals generated by an obstruction sensor of the LIDAR system resulted from an illumination of the window by one or more obstruction illumination sources that differ from one or more objects related illumination sources configured to transmit light in relation to the detection of the one or more objects.

According to an embodiment, the one or more obstruction illumination sources are multiple obstruction illumination sources and the method comprises illuminating different areas of the window by the multiple obstruction illumination sources.

According to an embodiment, the one or more obstruction illumination sources are multiple obstruction illumination sources and the method includes generating, by the multiple obstruction illumination sources, illumination beams that differ from each other by at least one parameter out of wavelength and size.

According to an embodiment, the one or more obstruction illumination sources include an obstruction illumination source that emits radiation having a wavelength that differs from a wavelength of light transmitted by the LIDAR system for the detection of the one or more objects.

According to an embodiment, the LIDAR system includes the one or more obstruction illumination sources.

According to an embodiment, the one or more obstruction illumination sources include a total immersion reflection (TIR) illumination obstruction radiation source.

According to an embodiment, step 1720 includes detecting the obstruction also based on illumination information indicative of portions of the window that were illuminated, at different points in time, by light transmitted by the LIDAR system during an objects detection period of time. For example—using the scanning pattern of the FOV is used to determine which areas of the window are illuminated.

According to an embodiment, the LIDAR system includes the obstruction sensor.

According to an embodiment, the LIDAR system includes the object related sensor of the LIDAR system.

According to an embodiment, step 1720 includes detecting the obstruction by comparing between reference clean window detection signals of the obstruction sensor to the detection signals generated by the obstruction sensor.

According to an embodiment, the comparing is a threshold based comparison—there is a need of at least a difference that exceeds a threshold to provide an indication of a potential obstruction.

According to an embodiment, step 1720 includes detecting the obstruction by comparing different detection signals of the detection signals generated by the obstruction sensor. For example—the correlation between (of differences between) different pixels of an image acquired by the obstruction sensor can provide an indication of the presence of obstructions—a non-obscured pixel of the window will reflect much less light than an obscured pixel of the window.

According to an embodiment, step 1720 includes detecting the obstruction by performing pattern recognition.

According to an embodiment, step 1720 includes detecting the obstruction based on the detection signals generated by the obstruction sensor and based on the detection signals generated by the object related sensor.

According to an embodiment, the method includes triggering an acquisition of the detection signals generated by the obstruction sensor when the window is illuminated by at least a predefined amount of ambient light.

According to an embodiment, method 1700 is executable by any of the LIDAR systems illustrated in relation to FIGS. 7A-14.

There may be provided a LIDAR system for projecting light through a window associated with the LIDAR system, the system includes at least one processor configured to detect, based on detection signals generated by an obstruction sensor of the LIDAR system, an obstruction that at least partially obstructs a passage of light through the window; and wherein the obstruction sensor differs from an object related sensor of the LIDAR system that is configured to detect of one or more objects within a field of view (FOV) of the LIDAR system.

According to an embodiment, the at least one processor is configured to detect the obstruction while ignoring detection signals generated by the object related sensor.

According to an embodiment, at least one processor is configured to detect the one or more objects while ignoring detection signals generated by the obstruction sensor.

According to an embodiment, at least one processor is configured to (i) receive the detection signals generated by the obstruction sensor during one or more obstruction detection periods of time, and (ii) receive detection signals generated by the object related sensor during one or more objects detection periods of time, wherein the one or more obstruction detection periods of time do not overlap the one or more objects detection periods of time.

According to an embodiment, a resolution of the obstruction sensor is smaller than an area of the window that is instantaneously illuminated by a transmission of light by the LIDAR system during an objects detection period of time.

According to an embodiment, the obstruction sensor exhibits an adjustable exposure period.

According to an embodiment, a duration of the adjustable exposure period is determined based on a duration of a scanning of the FOV of the LIDAR system.

According to an embodiment, a length of the adjustable exposure period is determined based on a desired coverage of the window.

According to an embodiment, the obstruction sensor has a first sensitivity to solar radiation and a second sensitivity to radiation generated by the LIDAR that illuminates the window, wherein the first sensitivity is lower than the second sensitivity.

According to an embodiment, the obstruction sensor is insensitive to a light transmitted by the LIDAR system in relation to the detection of one or more objects.

According to an embodiment, the obstruction sensor is sensitive to a light transmitted by the LIDAR system in relation to the detection of one or more objects.

According to an embodiment, the detection signals generated by an obstruction sensor of the LIDAR system resulted from an illumination of the window by one or more obstruction illumination sources that differ from one or more objects related illumination sources configured to transmit light in relation to the detection of the one or more objects.

According to an embodiment, the one or more obstruction illumination sources are multiple obstruction illumination sources that are configured to illuminate different areas of the window.

According to an embodiment, the one or more obstruction illumination sources are multiple obstruction illumination sources that are configured to generate illumination beams that differ from each other by at least one parameter out of wavelength and size.

According to an embodiment, the one or more obstruction illumination sources includes s an obstruction illumination source that emits radiation having a wavelength that differs from a wavelength of light transmitted by the LIDAR system for the detection of the one or more objects.

According to an embodiment, the LIDAR system includes the one or more obstruction illumination sources.

According to an embodiment, the one or more obstruction illumination sources include a total immersion reflection (TIR) illumination obstruction radiation source.

According to an embodiment, the at least one processor is configured to detect the obstruction also based on illumination information indicative of portions of the window that were illuminated, at different points in time, by light transmitted by the LIDAR system during an objects detection period of time. For example—using the scanning pattern of the FOV is used to determine which areas of the window are illuminated.

According to an embodiment, the LIDAR system includes the obstruction sensor.

According to an embodiment, the LIDAR system includes the object related sensor of the LIDAR system.

According to an embodiment, the LIDAR system includes the at least one processor is configured to detect the obstruction by comparing between reference clean window detection signals of the obstruction sensor to the detection signals generated by the obstruction sensor.

According to an embodiment, the comparing is a threshold based comparison—there is a need of at least a difference that exceeds a threshold to provide an indication of a potential obstruction.

According to an embodiment, the at least one processor is configured to detect the obstruction by comparing different detection signals of the detection signals generated by the obstruction sensor. For example—the correlation between (of differences between) different pixels of an image acquired by the obstruction sensor can provide an indication of the presence of obstructions—a non-obscured pixel of the window will reflect much less light than an obscured pixel of the window.

According to an embodiment, the at least one processor is configured to detect the obstruction by performing pattern recognition.

According to an embodiment, the at least one processor is configured to detect the obstruction based on the detection signals generated by the obstruction sensor and based on the detection signals generated by the object related sensor.

According to an embodiment, the at least one processor is configured to trigger an acquisition of the detection signals generated by the obstruction sensor when the window is illuminated by at least a predefined amount of ambient light.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

We claim:

1. A LIDAR system for detecting an obstruction on a window that is associated with the LIDAR system, the LIDAR system comprising:
at least one processor configured to detect, based on detection signals generated by an obstruction sensor of the LIDAR system, an obstruction that at least partially obstructs a passage of light through the window;
wherein the obstruction sensor differs from an object related sensor of the LIDAR system that is configured to detect of one or more objects within a field of view (FOV) of the LIDAR system.

2. The LIDAR system according to claim 1, wherein the at least one processor is configured to detect the obstruction while ignoring detection signals generated by the object related sensor.

3. The LIDAR system according to claim 1, wherein the at least one processor is configured to (i) receive the detection signals generated by the obstruction sensor during one or more obstruction detection periods of time, and (ii) receive detection signals generated by the object related sensor during one or more objects detection periods of time, wherein the one or more obstruction detection periods of time do not overlap the one or more objects detection periods of time.

4. The LIDAR system according to claim 1, wherein a resolution of the obstruction sensor is smaller than an area of the window that is instantaneously illuminated by a transmission of light by the LIDAR system during an objects detection period of time.

5. The LIDAR system according to claim 1, wherein the obstruction sensor exhibits an adjustable exposure period.

6. The LIDAR system according to claim 1, wherein the detection signals generated by an obstruction sensor of the LIDAR system resulted from an illumination of the window by one or more obstruction illumination sources that differ from one or more objects related illumination sources configured to transmit light in relation to the detection of the one or more objects.

7. The LIDAR system according to claim 6, wherein the one or more obstruction illumination sources are multiple obstruction illumination sources that are configured to illuminate different areas of the window.

8. The LIDAR system according to claim 6, wherein the one or more obstruction illumination sources are multiple obstruction illumination sources that are configured to generate illumination beams that differ from each other by at least one parameter out of wavelength and size.

9. The LIDAR system according to claim 6, wherein the one or more obstruction illumination source comprise a total immersion reflection (TIR) illumination.

10. The LIDAR system according to claim 1, wherein the at least one processor is configured to detect the obstruction also based on illumination information indicative of portions of the window that were illuminated, at different points in time, by light transmitted by the LIDAR system during an objects detection period of time.

11. The LIDAR system according to claim 1, comprising the obstruction sensor.

12. The LIDAR system according to claim 11, comprising the object related sensor of the LIDAR system.

13. The LIDAR system according to claim 1, wherein the at least one processor is configured to detect the obstruction by comparing between reference clean window detection signals of the obstruction sensor to the detection signals generated by the obstruction sensor.

14. The LIDAR system according to claim 13, wherein the comparing is a threshold based comparison.

15. The LIDAR system according to claim 1, wherein the obstruction sensor has a depth of field (DOF) near limit and a DOF far limit, wherein the window is positioned between the DOF near limit and the DOF far limit, wherein a distance between the window and the DOF far limit does not exceed fifteen centimeters.

16. The LIDAR system according to claim 15, wherein the DOF of the obstruction sensor differs than a DOF of the object related sensor.

17. The LIDAR system according to claim 1, at least one processor configured to detect the obstruction based on the detection signals generated by the obstruction sensor and based on the detection signals generated by the object related sensor.

18. The LIDAR system according to claim 1, wherein the least one processor is configured to trigger an acquisition of the detection signals generated by the obstruction sensor when the window is illuminated by at least a predefined amount of ambient light.

19. A method for detecting an obstruction formed on a window associated with a LIDAR system, the method comprising:
receiving, by at least one processor associated with the LIDAR system, detection signals generated by an obstruction sensor of the LIDAR system; wherein the obstruction sensor differs from
an object related sensor of the LIDAR system that is configured to detect of one or more objects within a field of view (FOV) of the LIDAR system; and
detecting the obstruction, by the at least one processor, based on the detection signals generated by an obstruction sensor of the LIDAR system, wherein the obstruction at least partially obstructs a passage of light through the window.

20. A non-transitory computer readable medium for detecting an obstruction formed on a window associated with a LIDAR system, the non-transitory computer readable medium stores instructions that once executed by at least one processor that is associated with the LIDAR system, cause the at least one processor to:
receive detection signals generated by an obstruction sensor of the LIDAR system; wherein the obstruction sensor differs from an object related sensor of the LIDAR system that is configured to detect of one or more objects within a field of view (FOV) of the LIDAR system; and
detect the obstruction based on the detection signals generated by an obstruction sensor of the LIDAR system, wherein the obstruction at least partially obstructs a passage of light through the window.
